(19) United States
(12) Patent Application Publication
(10) Pub. No.: US 2008/0038163 A1
(43) Pub. Date: Feb. 14, 2008

(54) Systems and Methods for Cooling in Biological Analysis Instruments

(75) Inventors: Steven J. Boege, San Mateo, CA (US); John Andrew Sheridan, Marblehead, MA (US); Ali P. Aslam, Salem, MA (US); Dennis Lehto, Santa Clara, CA (US); Julio P. Focaracci, San Mateo, CA (US); Alexander Dromaretsky, Davis, CA (US); Thomas C. Au, Palo Alto, CA (US); Mark F. Oldham, Los Gatos, CA (US); Eric G. Henderson, Fremont, CA (US); Vinod Mirchandani, San Ramon, CA (US); Eric S. Nordman, Palo Alto, CA (US); Marc Haberstroh, San Jose, CA (US); Johannes P. Sluis, Redwood City, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 11/757,286

(22) Filed: Jun. 1, 2007

Related U.S. Application Data
(60) Provisional application No. 60/816,133, filed on Jun. 23, 2006.
(60) Provisional application No. 60/816,192, filed on Jun. 23, 2006.

(51) Int. Cl. F28F 99/00; B01J 19/00

(52) U.S. Cl. 422/188; 422/198

(57) ABSTRACT

A device for performing biological analysis may include at least one reaction chamber configured to receive at least one sample for biological analysis and a thermal system configured to modulate a temperature of the at least one reaction chamber to cycle a temperature of the at least one biological sample. The thermal system may include a cooling system configured to cool the at least one reaction chamber. The cooling system may include a cooling fluid source positioned distally from the at least one reaction chamber, the cooling fluid source being in flow communication with at least one conduit configured to flow cooling fluid from the cooling fluid source to at least one location in thermal communication with the at least one reaction chamber.

This application claims the benefits of priority of U.S. Provisional Application No. 60/816,133, filed Jun. 23, 2006, entitled “Cooling in a Thermal Cycler Using Heat Pipes,” and of U.S. Provisional Application No. 60/816,192, filed Jun. 23, 2006, entitled “Systems and Methods for Cooling in a Thermal Cycler,” the entire contents of both of which are incorporated by reference herein.

### DESCRIPTION

1. Field

The present teachings pertain generally to instruments for performing biological and/or biochemical reactions and/or analyses. More particularly, the present teachings are directed to systems and methods useful for cooling biological samples contained in reaction chambers of such instruments, such as, for example, flow cell instruments used for sequencing and/or for performing other biological analyses and/or reactions.

2. Introduction

A significant parameter in many methods relying on biological and/or biochemical reactions is the temperature at which the reaction and/or stages of the reaction take place. Many such reactions involve controlling the temperature of the constituent reaction components to achieve desired reaction stages. Control over the temperature may include cycling the temperature of the reaction through differing temperatures, for example, corresponding to differing stages of the reaction.

For example, when amplifying nucleic acid using polymerase chain reaction (PCR), alternating steps of melting DNA, annealing short primers to the resulting single DNA strands, and extending those primers to make new copies of double-stranded DNA relies on repeated thermal cycling from high temperatures of about 90° C. for melting the DNA, to lower temperatures of approximately 40° C. to 70° C. for primer annealing and extension.

Biological sequencing also may require controlling the temperature of the reaction and/or sample undergoing reaction, for example, by holding the temperature at a preset level and/or cycling the temperature in a manner similar to thermal cycling in PCR. By way of example, some sequencing by synthesis methods include various cycles of extension, ligation, cleavage, and/or hybridization in which it may be desired to cycle the temperature. Further, in some sequencing techniques, temperatures may range from about 0° C. to about 20° C., at which imaging of the reaction may occur, to a higher temperature ranging from about 60° C. to about 100° C. for denaturation and/or other reaction stages.

Generally, when cycling the temperature of a reaction (or one or more samples undergoing reaction), it is desirable to change the sample temperature to the next temperature in the cycle as rapidly as possible for several reasons. First, a reaction has an optimum temperature for each of its stages. Thus, less time spent at non-optimum temperatures may achieve a better result. Another reason is that a minimum time for holding the reaction mixture at each temperature may be required after each desired temperature is reached. These minimum incubation times establish the “floor” or minimum time it takes to complete an entire cycle (e.g., for PCR, sequencing, etc.). Any time transitioning between temperatures is time added to this minimum cycle time, which therefore leads to decreased throughput. Since the number of cycles can be fairly large, this additional time undesirably lengthens the total time needed to complete the biochemical and/or chemical process desired, and thus leads to slower overall processing times.

Moreover, in sequencing, it may be desirable to control the temperature during analysis, such as, for example, during data acquisition and/or other monitoring of fluorescence signals. By way of example, when optically imaging, including, for example, detecting fluorescence signals from, a biological sample during a sequencing process, controlling the temperature of the sample may be important to obtain accurate results.

In some conventional automated biological analysis instruments, such as, for example, flow cell instruments that are configured to receive a sample to be reacted and/or analyzed (e.g., a substrate holding synthesized nucleic acid templates), the temperature of the flow cell may be controlled by a thermoelectric (Peltier) device in thermal communication with a heat sink to which a fan is mounted to circulate air thereto and dissipate heat. An example of such a thermal system is depicted in FIGS. 1 and 2, which respectively show a partial perspective and partial perspective, cross-sectional view of a biological analysis instrument in the form of a dual flow cell 201. The flow cells shown in FIGS. 1 and 2, include a common cover 204 that mates with two heater sample blocks 212 (only one of which is shown in FIG. 2) to form two reaction chambers configured to receive one or more biological samples for analysis. The dual flow cell 201 includes a common Peltier device 260 underlying the sample blocks 212 and a common heat sink 280. A liquid-filled chamber 218 may be present between the blocks 212 and sample holders 210 that are supported on the blocks 212. Each block 212 is configured to support a sample holder 210 that, in one exemplary embodiment, is in the form of a microscope slide configured to hold a biological sample. Two fans 290 are positioned adjacent and substantially in contact with the heat sink 280 to dissipate heat therefrom, with each fan 290 substantially corresponding to a flow cell 201. Due to the fans 290 being placed directly in contact with the heat sink 280 (e.g., proximate to the flow cell 201, the size of the fans 290, and therefore capacity, may be relatively small. By way of example, each of the fans 290 may have a capacity of about 14 cubic feet/minute (cfm).

The location of a fan proximate the biological analysis instrument, such as, for example, proximate the flow cell, may cause undesired vibrations, air currents, and/or other physical movements that may negatively impact image detection since the optics used for imaging in such devices may be relatively sensitive. Moreover, such movements may in turn cause undesired movement of the reaction chamber and/or the sample in the reaction chamber. By way of example, the proximity of a fan with a flow cell instrument (e.g., such as is shown in FIGS. 1 and 2) used for sequencing may cause movement of fluorescing tags, and even slight movement of those tags can cause blurriness and other impedances during detection and imaging. Vibration of the reaction chamber with proximate, axial fans, such as, for example, those depicted in FIGS. 1 and 2, may be on order of 1-10 microns at 20-200 Hz.

Also, the location of various components of the cooling system, such as, for example, the fan, in the proximity of the flow cell may cause other physical effects, such as, for example, condensation, excess heat, etc. that may negatively impact obtaining accurate imaging of the reaction and/or reaction products occurring within the reaction chamber. For example, providing a fan in the proximity of the flow cell may hinder circulating cool air to cool the reaction chamber since the fan may draw in heated air from surrounding components. Also, in the case of flow cells used for sequencing, for example, heat effects of the temperature control components may influence the fluorescence signals.

Further, in some conventional automated biological analysis instruments, the temperature of a sample block (e.g., a heater block which may be made of metal, for example, a metal having a relatively high thermal conductivity, such as, aluminum, copper, silver, and/or metal alloy, or other suitable material) which may be configured to hold containers, holders, substrates, etc. containing one or more samples or may be configured to permit a sample to be in direct contact therewith, is controlled according to prescribed temperatures and times specified by the user in a temperature protocol file. A computer and associated electronics may control the temperature of the block in accordance with the protocol file defining the times, temperatures and number of cycles, etc. As the block changes temperature, the one or more samples may follow with similar changes in temperature. However, in some conventional instruments not all samples experience the same temperature cycle. Errors in sample temperature may be generated by nonuniformity of temperature from place to place within the block, for example, temperature variability may exist within the metal of the block thereby undesirably causing some samples to have different temperatures than other samples at particular times in the cycle. Further, there may be delays in transferring heat from the block to the sample, but the delays may not be the same for all samples.

In other conventional automated biological analysis instrument systems, one or more samples may be heated and/or cooled without the use of a block. For example, in such systems, air or other fluid may be circulated directly around a sample holder (e.g., capillaries, reaction tubes, a substrate, such as, a microarray, a microtiter plate, etc.). The temperature of the sample in such systems also may be relatively difficult to control, e.g., such that all of the samples reach the same temperature and/or change temperatures substantially simultaneously. In other words, in such systems, undesirable temperature variations among the samples may occur. Further, it may be difficult to change the temperature of the samples in an efficient manner using direct cooling and/or heating via circulating fluid.

To perform biological sample analysis, such as, for example, sequencing, PCR, and/or other analyses, successfully and efficiently, it is desirable to minimize time delays and temperature errors (e.g., undesirable temperature variations) that may occur in conventional instruments. Minimizing time delays for heat transfer to and from the samples in a reaction chamber of a biological analysis instrument and minimizing temperature errors due to undesirable temperature variability (nonuniformity) may become particularly acute when the size of the region containing samples becomes large.

When using a block (e.g., a metal block) to conduct heat with the samples, the size of block necessary to heat and cool, for example, a microtiter plate having at least 96 samples in an 8×12 well array on 9 millimeter centers, a substrate, and/or other sample holder, is fairly large. This large area block creates multiple engineering challenges for the design of a biological assay instrument that is capable of heating and cooling such a block very rapidly in a temperature range generally from 0° C. to 100° C., for example. These challenges arise from several sources. First, the large thermal mass of the block makes it difficult to move the block temperature up and down in the operating range with great rapidity. Second, in some conventional instruments, the need to attach the block to various external devices such as manifolds for supply and withdrawal of cooling fluid, block support attachment points, and associated other peripheral equipment creates the potential for temperature variations to exist across the block which exceed tolerable limits.

There are also numerous other conflicts between the requirements in the design of a thermal cycling system for automated performance of sequencing, PCR, and/or other reactions requiring rapid, accurate temperature cycling of a large number of samples. For example, to change the temperature of a metal block and/or the samples rapidly, a large amount of heat must be added to, or removed from the block and/or the samples in a short period of time. However, it may be difficult to add or remove large amounts of heat rapidly and efficiently without causing large differences in temperature from place to place in the block and/or the sample holders, thereby forming temperature variability which can result in nonuniformity of temperature among the samples.

Even after the process of addition or removal of heat is terminated, temperature variability can persist for a time roughly proportional to the square of the distance that the heat stored in various points in the block must travel to cooler regions to eliminate the temperature variance. Thus, as a block is made larger to accommodate more samples, the time it takes for temperature variability existing in the block to decay after a temperature change causes temperature variance which extends across the largest dimensions of the block can become markedly longer. This makes it increasingly difficult to cycle the temperature of the sample block rapidly while maintaining accurate temperature uniformity among all the samples.

Because of the time required for temperature variations to dissipate, an important need has arisen in the design of biological analysis instruments to minimize the creation of undesired temperature variablity that may extend over large distances. Thus, it may be desirable to provide a thermal system wherein the sample block (e.g., heater block) can be cooled in a rapid, efficient, and uniform manner. It also may be desirable to provide a biological analysis instrument wherein the sample holder can be directly cooled and/or heated in an efficient and rapid manner, for example, without the use of a block. It may be desirable to provide a biological analysis instrument that is capable of achieving sub-ambient temperatures.

On the other hand, there also may be a need in some biological analysis applications to obtain desired temperature gradients among one or more samples, e.g., at certain locations of the sample holders or sample block. Thus, it may be desirable to provide a thermal cycler with a cooling system capable of creating desired temperature gradients (e.g., controlled temperature gradients).

### SUMMARY

The present invention may satisfy one or more of the above-mentioned desirable features. Other features and/or advantages may become apparent from the description which follows.

In accordance with various exemplary aspects of the disclosure, a device for performing biological analysis may include at least one reaction chamber configured to receive at least one sample for biological analysis and a thermal system configured to modulate a temperature of the at least one reaction chamber to cycle a temperature of the at least one biological sample. The thermal system may include a cooling system configured to cool the at least one reaction chamber. The cooling system may include a cooling fluid source positioned distally from the at least one reaction chamber, the cooling fluid source being in flow communication with at least one conduit configured to flow cooling fluid from the cooling fluid source to at least one location in thermal communication with the at least one reaction chamber.

In accordance with various exemplary aspects of the disclosure, a device for performing biological analysis may include at least one reaction chamber configured to receive at least one sample for biological analysis and a thermal system configured to modulate a temperature of the at least one reaction chamber to cycle a temperature of the at least one biological sample. The thermal system may include a cooling system configured to minimize physical movement of the at least one reaction chamber caused by the cooling system.

According to yet other exemplary aspects of the disclosure, a method of performing biological analysis may include supplying at least one reaction chamber with at least one biological sample for biological analysis and modulating a temperature of the at least one reaction chamber to cycle a temperature of the at least one biological sample. Modulating the temperature of the at least one reaction chamber may include cooling the at least one reaction chamber and the cooling may include flowing a cooling fluid from a cooling fluid source positioned distally from the at least one reaction chamber to at least one location proximate to and in thermal communication with the at least one reaction chamber via at least one conduit.

In various exemplary aspects of the disclosure, a method for performing biological analysis may include supplying at least one reaction chamber with at least one biological sample for biological analysis and modulating a temperature of the at least one reaction chamber to cycle a temperature of the at least one biological sample. Modulating the temperature of the at least one reaction chamber may include cooling the at least one reaction chamber, wherein cooling the at least one reaction chamber includes minimizing physical movement of the at least one reaction chamber caused by the cooling.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

### BRIEF DESCRIPTION OF THE DRAWINGS

FIG. 1 is a side perspective view of an embodiment of a cooling system for a flow cell;

FIG. 2 is perspective cross-sectional view of the embodiment of FIG. 1;

FIG. 3 is block diagram of an exemplary embodiment of a biological analysis instrument;

FIG. 4 is a block diagram of another exemplary embodiment of a biological analysis instrument;

FIG. 5 is a block diagram of an exemplary embodiment of a cooling system of a biological analysis instrument in accordance with aspects of the disclosure;

FIG. 6 is a block diagram of an exemplary embodiment of a cooling system of a biological analysis instrument in accordance with aspects of the disclosure;

FIG. 7 is a block diagram of an exemplary embodiment of a cooling system of a biological analysis instrument in accordance with aspects of the disclosure;

FIG. 8 is a block diagram of an exemplary embodiment of a cooling system of a biological analysis instrument in accordance with aspects of the disclosure;

FIG. 9 is a partial perspective view of an exemplary embodiment of a biological analysis instrument and cooling system;

FIG. 10 is a partial perspective view of the exemplary embodiment of FIG. 9 in a position when in use for reaction and analysis of a biological sample;

FIG. 10A is a partial cross-sectional perspective view of the exemplary embodiment of FIG. 10;

FIG. 11 is a schematic perspective view of an exemplary embodiment of a cooling system in accordance with aspects of the disclosure;

FIG. 12 is a schematic perspective view of another exemplary embodiment of a cooling system in accordance with aspects of the disclosure;

FIG. 13 is a schematic, isometric view of a cooling module of the cooling systems of FIGS. 11 and 12;

FIG. 14 is a partial plan view of a cooling system similar to the exemplary embodiment of FIG. 11 in use with a flow cell in accordance with aspects of the disclosure;

FIG. 15 is a block diagram of a biological analysis instrument with a cooling system utilizing heat pipe technology in accordance with aspects of the disclosure;

FIG. 16 is a block diagram of a biological analysis instrument and a schematic perspective view of a cooling system utilizing heat pipe technology according to aspects of the disclosure;

FIG. 17 is a block diagram of an exemplary embodiment of a carbon block in combination with a cooling system for a biological analysis instrument;

FIGS. 18A-18B are views of exemplary embodiments of the carbon block taken along line 18-18 of FIG. 17;

FIG. 19 is a partial perspective view of the exemplary embodiment of FIG. 9 showing an exemplary embodiment of a switch according to aspects of the disclosure;

FIG. 20 is a schematic perspective view of yet another exemplary embodiment of a cooling system according to aspects of the disclosure; and

FIG. 21 is a plan view of an exemplary embodiment of a partitioned reaction chamber according to aspects of the disclosure.

### DETAILED DESCRIPTION OF VARIOUS EMBODIMENTS

Reference will now be made to various embodiments, examples of which are illustrated in the accompanying drawings. However, these various exemplary embodiments are not intended to limit the disclosure. On the contrary, the disclosure is intended to cover alternatives, modifications, and equivalents.

With respect to containers, holders, chambers, wells, recesses, tubes, capillaries, arrays, and/or locations used in conjunction with plates, trays, cards, substrates, and/or alone, as used herein, such structures may be “micro” structures, which refers to the structures being configured to hold a small (micro) volume of fluid; e.g., no greater than about 500 μl, for example, about 250 μl to about 450 μl. In various embodiments, such structures are configured to hold no more than 100 μl, no more than 75 μl, no more than 50 μl, no more than 25 μl, or no more than 1 μl. In some embodiments, such structures can be configured to hold, for example, about 30 μl. In yet other embodiments, such structures may be configured to hold no more than about 10 μl. In various exemplary embodiments, the volume of reaction chambers defined by flow cells may be configured to hold about 450 μl.

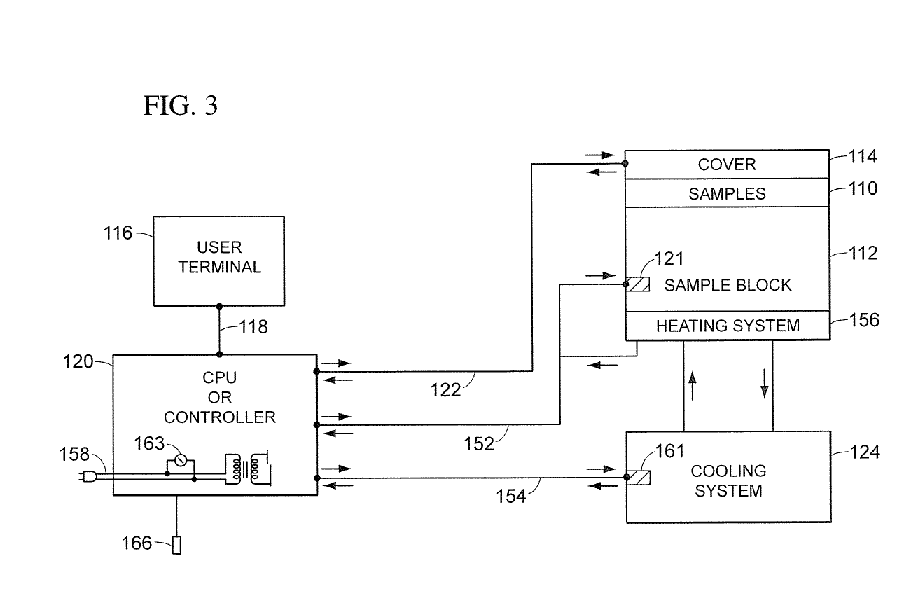

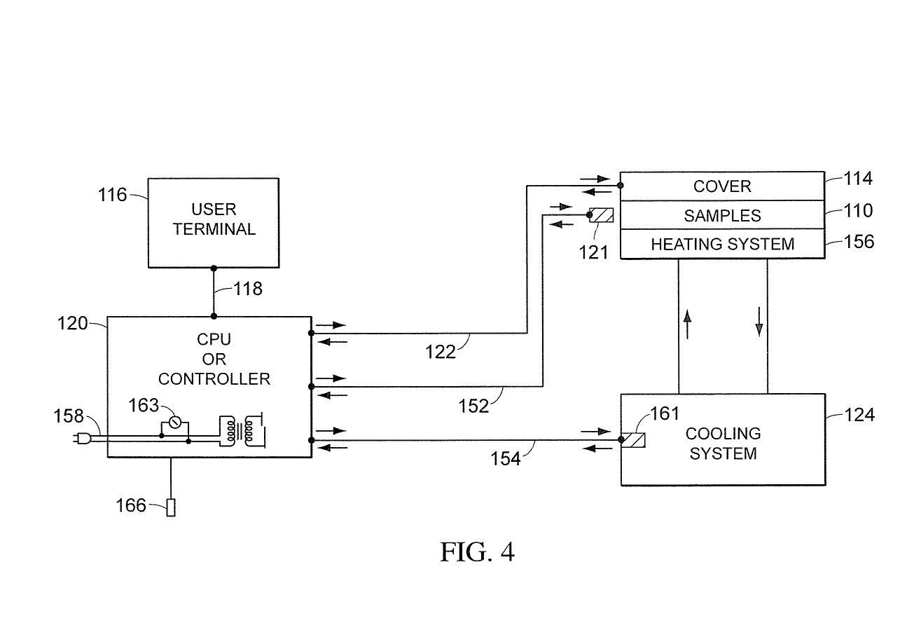

Referring to FIGS. 3 and 4, a block diagram of the major system components of exemplary embodiments of an instrument for performing biological analysis according to the exemplary aspects of the disclosure is shown. With reference to FIG. 3, sample mixtures 110, including, for example, DNA to be amplified and/or sequenced, are placed in conjunction with the temperature-programmed sample block 112 and are covered by a cover 114. The cover 114 may be a heated cover, for example, if the instrumentation under consideration is a PCR instrument. The sample block 112 may be a metal block constructed, for example, from silver, aluminum, copper, stainless steel, and/or a metal alloy or other metal having a relatively high thermal conductivity. With reference to FIG. 4, this exemplary embodiment does not include a sample block. Rather, the samples 110 may be directly heated and/or cooled within a reaction chamber of the biological analysis instrument. In FIG. 4, the samples 110 may be either placed directly within a reaction chamber or be held in a variety of types of sample holders, as described herein.

With either embodiment, a user may supply data defining time and temperature parameters (e.g., time-temperature profiles) of the desired reaction (e.g., PCR, sequencing and/or other reaction) protocol via a terminal 116 including a keyboard and display. The keyboard and display may be coupled via a data bus 118 to a controller 120 (sometimes referred to as a central processing unit or CPU). The controller 120 can include memory that stores a desired control program, data defining a desired PCR protocol, and certain calibration constants. Based on the control program, the controller 120 controls temperature cycling of the sample block 112 and/or holders containing the samples 110 and implements a user interface that provides certain displays to the user and receives data entered by the user via the keyboard of the terminal 116. It should be appreciated that the controller 120 and associated peripheral electronics to control the various heaters and other electro-mechanical systems of the biological analysis instrument and read various sensors can include any general purpose computer such as, for example, a suitably programmed personal computer or microcomputer.

Samples 110 can be held by a sample holder (e.g., in microcards, microplates, capillaries, substrates holding templates, microarrays, etc.) configured to be supported by the sample block 112. A cover 114 may be configured to substantially thermally isolate the samples from the ambient air. In one exemplary embodiment, the cover 114 may be heated and may contact a plastic disposable tray to form a heated, enclosed box in which the sample holders reside. Such an embodiment may be useful for performing PCR, for example. Further details regarding the cover and its cooperation with the sample block in an exemplary embodiment of a flow cell instrument are set forth below with reference to FIGS. 9, 10, and 14.

Sample holders may include, for example, recesses and/or wells in a microtiter plate, capillaries, tubes/microtubes, microfluidic devices/chambers, throughhole plates, sample trays, microarrays and other types of sample holders. Sample holders may also comprise various materials having locations for holding or retaining samples such as on a microcard or sample substrate including for example glass, plastic, polymer, metal, or combinations thereof. A substrate may be configured in numerous manners for example as a generally planar substrate, such as a microscope slide or planar array, configured to hold an array of templates or other samples, and/or other conventional sample holders used for biological analysis processes, such as, for example, PCR and/or sequencing. Such sample holders/substrates may be configured for use in numerous applications including thermocycling devices, incubation chambers, flow cell devices, and other sample processing devices.

In various embodiments, the cover 114 may serve, among other things, to reduce undesired heat transfer to and from the sample mixture by evaporation, condensation, and refluxing inside the sample tubes. It also may reduce the chance of cross-contamination by maintaining the insides of the caps of capillary tubes dry, thereby preventing aerosol formation when the tubes are uncapped. The heated cover may be in contact with the sample tube caps and/or other sealing mechanism around the sample holders to keep them heated to a temperature of approximately 104° C. or above the condensation points of the various components of the reaction mixture.

In the case of a heated cover 114, the controller 120 can include appropriate electronics to sense the temperature of the cover 114 and control electric resistance heaters therein to maintain the cover 114 at a predetermined temperature. Sensing of the temperature of the heated cover 114 and control of the resistance heaters therein is accomplished via a temperature sensor (not shown) and a data bus 122.

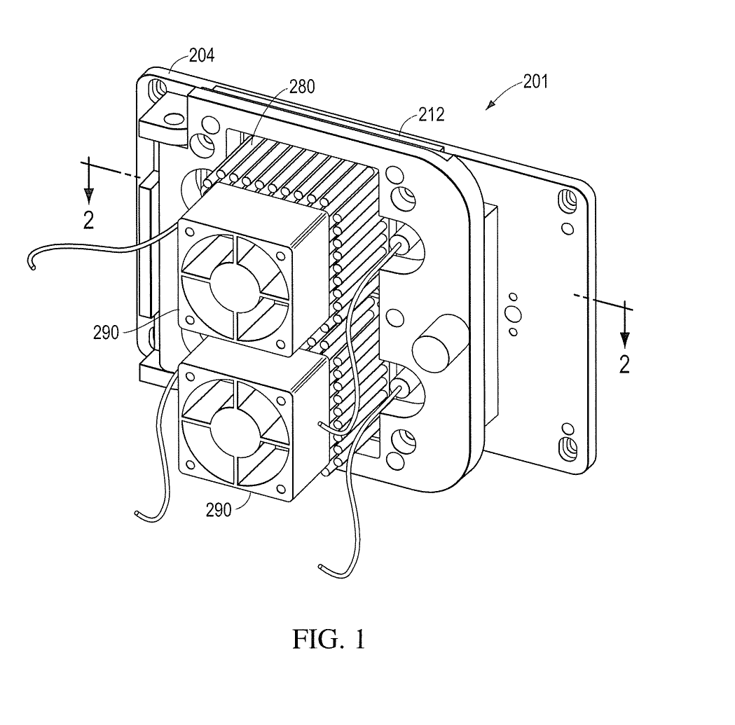

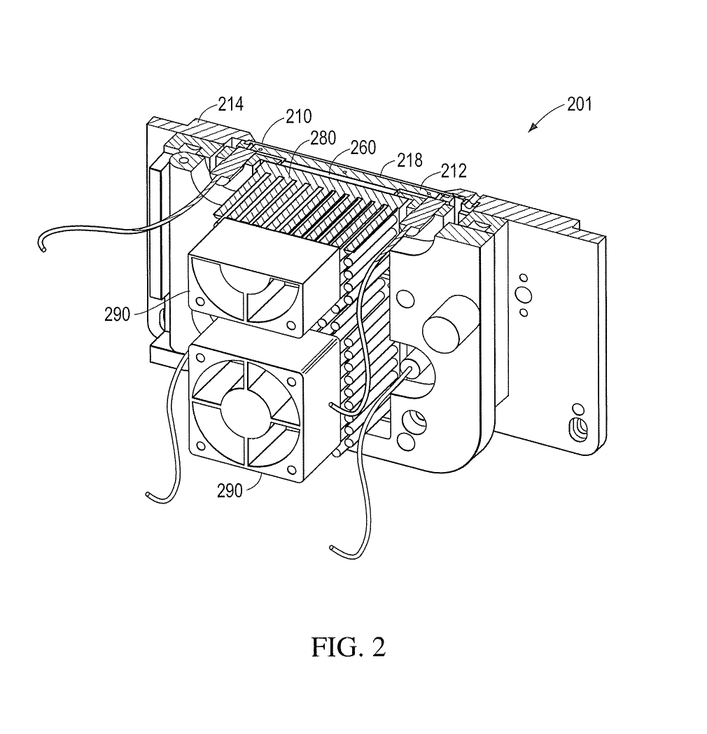

A cooling system 124, examples of which are discussed in more detail below, can provide suitable temperature control of the samples 110. According to some aspects, the cooling system 124 can be operated to achieve fast, efficient, and/or uniform temperature control of the samples 110. According to some aspects, the cooling system 124 can be operated to quickly and/or efficiently achieve a desired temperature gradient between various samples. According to yet further aspects, the cooling system 124 may be configured to reduce and/or minimize physical disturbances, other than cooling of the sample and/or a reaction chamber containing the sample, as compared with conventional cooling systems. In other words, a cooling system in accordance with various exemplary embodiments may be configured such that physical disturbances, such as, for example, vibration and/or other movements of the reaction chamber, condensation, residual exhaust heating, and/or other similar undesirable physical disturbances, are minimized. Regarding minimizing vibration and/or other movement, such minimization may enhance accuracy during optical detection, such as, for example, detection of fluorescing tags during sequencing using flow cells. Such minimization may reduce vibrations corresponding to proximally disposed fans, as described above with reference to FIGS. 1 and 2. Regarding minimizing condensation, exhaust heat, and/or other undesired heat transfer effects, such minimization may also enhance accuracy during optical detection by reducing any undesired heating of sensitive fluorescing tags that may influence emission. Further, such minimization also may enhance accuracy by providing greater control over the desired reaction temperature.

According to an exemplary embodiment, the instruments of FIGS. 3 and 4 can be enclosed within a housing (not shown). Any heat being expelled to the ambient air can be kept within the housing to aid in evaporation of any condensation that may occur. This condensation can cause corrosion of metals used in the construction of the unit or the electronic circuitry and should be removed. Expelling the heat inside the enclosure helps evaporate any condensation to prevent corrosion. On the other hand, portions of the system may be contained within a housing and portions may be disposed outside the housing or in a separate housing, wherein multiple housings may be connected to each other. Such an arrangement may be useful when it is desired to minimize physical effects, such as heat caused by exhausting heated air and/or other heating effects of the cooling components, of the cooling system on the reaction chamber and sample contained therein.

As noted above, the temperature protocol for performing a biological analysis may involve incubations at least two or more different temperatures. These temperatures can be substantially different, and, therefore, means must be provided to move the temperature of the reaction mixture of all the samples relatively rapidly from one temperature to another. The cooling system 124 is configured to reduce the temperature of the samples 110 from a high temperature (such as, for example, denaturation incubation in PCR or ligation and/or reset (e.g., melting of the template) in sequencing) to a lower temperature (such as, for example, hybridization and extension incubation temperatures in PCR or imaging in sequencing). Additionally, the cooling system 124 may be used to draw away undesired/unnecessary heat from a selected location or set of locations. Alternatively the cooling system 124 may be used to effectuate cooling of a selected location or set of locations. For example, the cooling system 124 may lower the temperature of the sample block 112 (FIG. 3) or may act to lower the temperature of holders containing the samples 110 or may act directly on the samples contained in a reaction chamber (either on one or more sample holders or the sample itself contained in the reaction chamber without a sample holder) (FIG. 4).

It should be appreciated that a ramp cooling system, in some exemplary embodiments, may also be used to maintain the sample temperature at or near the target incubation temperature. However, in some embodiments, small temperature changes in the downward direction to maintain target incubation temperature are implemented by a bias cooling system (e.g., a Peltier thermoelectric device), as is known to those skilled in the art.

A heating system 156, which may include, for example, a multi-zone heater, can be controlled by the controller 120 via a data bus 152 to rapidly raise the temperature of the sample block 112, the sample holders, and/or the reaction chamber to higher incubation temperatures from lower incubation temperatures. The heating system 156 also may correct temperature errors in the upward direction during temperature tracking and control during incubations.

The heating system may include but is not limited to, for example, film heaters, resistive heaters, heated air, infrared heating, convective heating, inductive heating (e.g. coiled wire), Peltier-based thermoelectric heating, and other heating mechanisms known to those skilled in the art. According to various exemplary embodiments, the cooling system and the heating system may be a single system configured to both increase and decrease the temperature of the block 112, the sample holders, and/or the sample directly (e.g., the reaction chamber).

In the exemplary embodiment of FIG. 3, the controller 120 controls the temperature of the sample block 112 by sensing the temperature of the sample block 112 and/or the temperature of fluid circulating within the sample block 112 via a temperature sensor 121 and the data bus 152 and by sensing the temperature of the cooling system 124 via bus 154 and a temperature sensor 161 in the cooling system 124. By way of example only, the temperature of the circulating fluid of the cooling system may be sensed, although other temperatures associated with the cooling system may also be sensed. The thermoelectric device may be controlled by sensing the sample block temperature via the sensor 121 and controlling current to the thermoelectric device. In the exemplary embodiment of FIG. 4, the controller 120 may control the temperature of the samples 110 by sensing the temperature of the samples 110 via a sensor 121 and the data bus 152. The sensor 121 in the embodiment of FIG. 4 may be, for example, a remote infrared temperature sensor or an optical sensor that detects a thermochromic dye in the samples 110. The controller 120 can also sense the internal ambient air temperature within the housing of the system via an ambient air temperature sensor 166. Further, the controller 120 can sense the line voltage for the input power on line 158 via a sensor 163. All these items of data together with items of data entered by the user to define the desired temperature protocol such as target temperatures and times for incubations are used by the controller 120 to carry out a desired temperature/time control program.

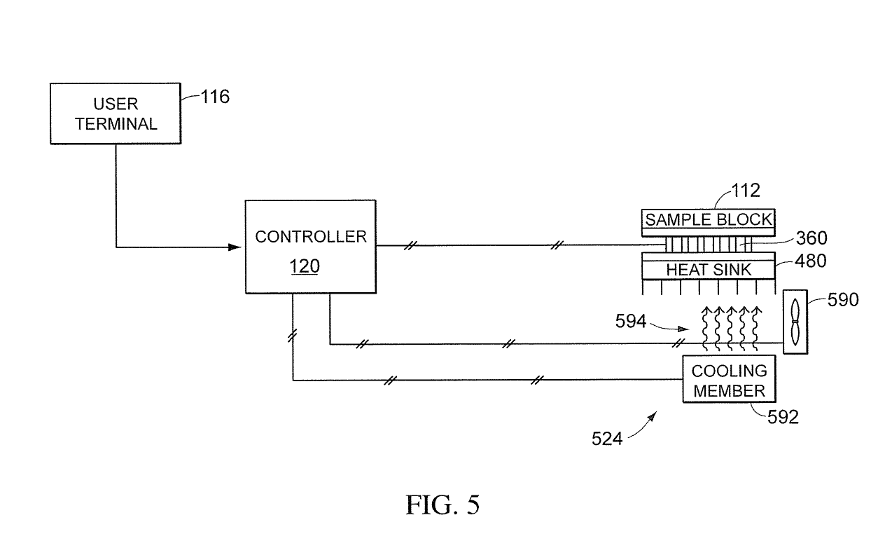

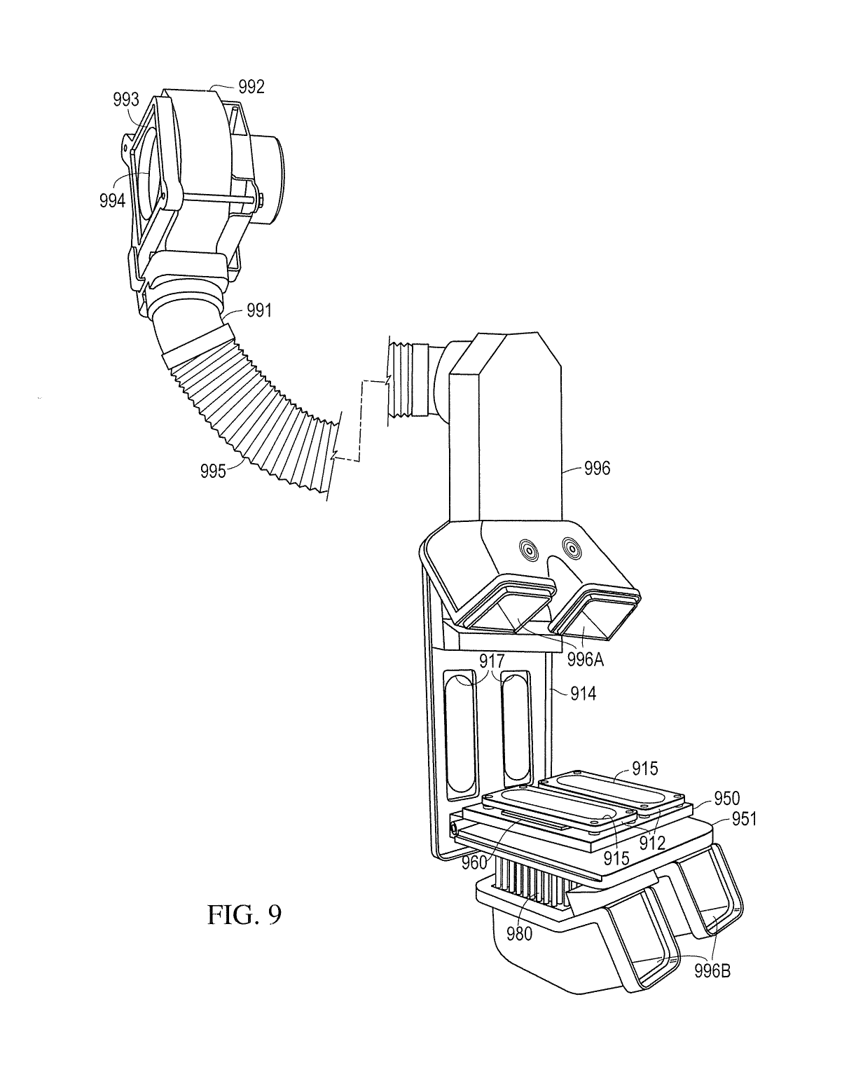

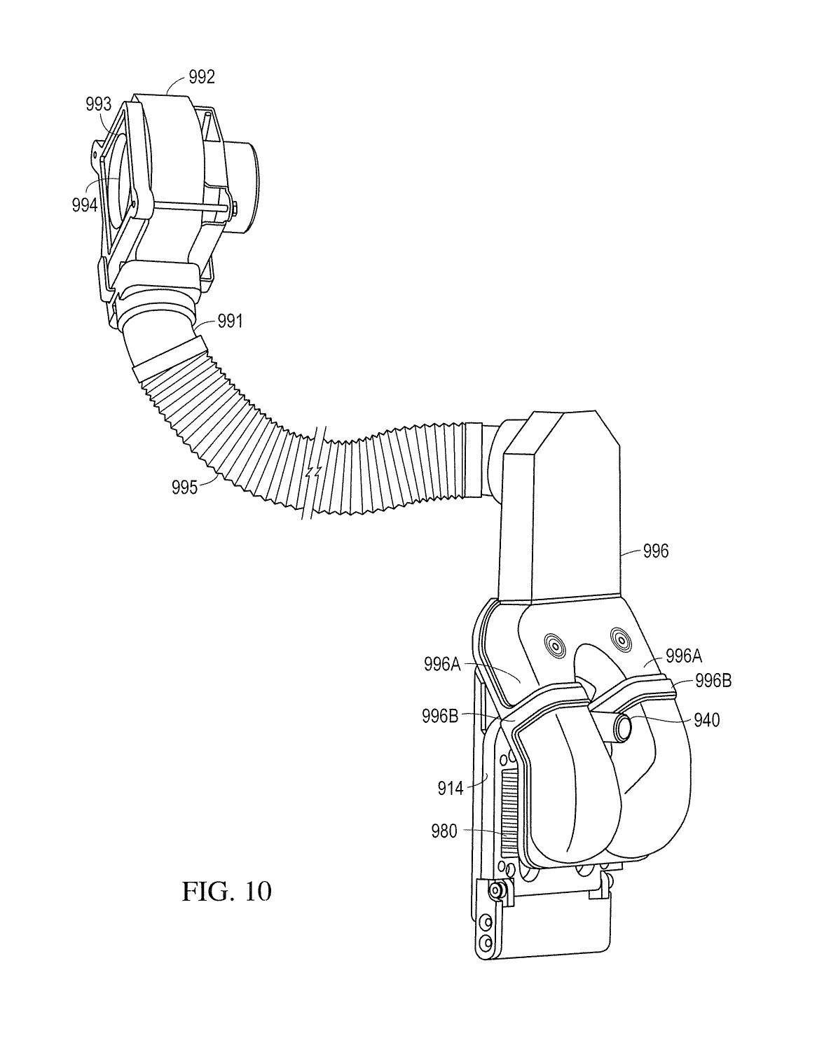

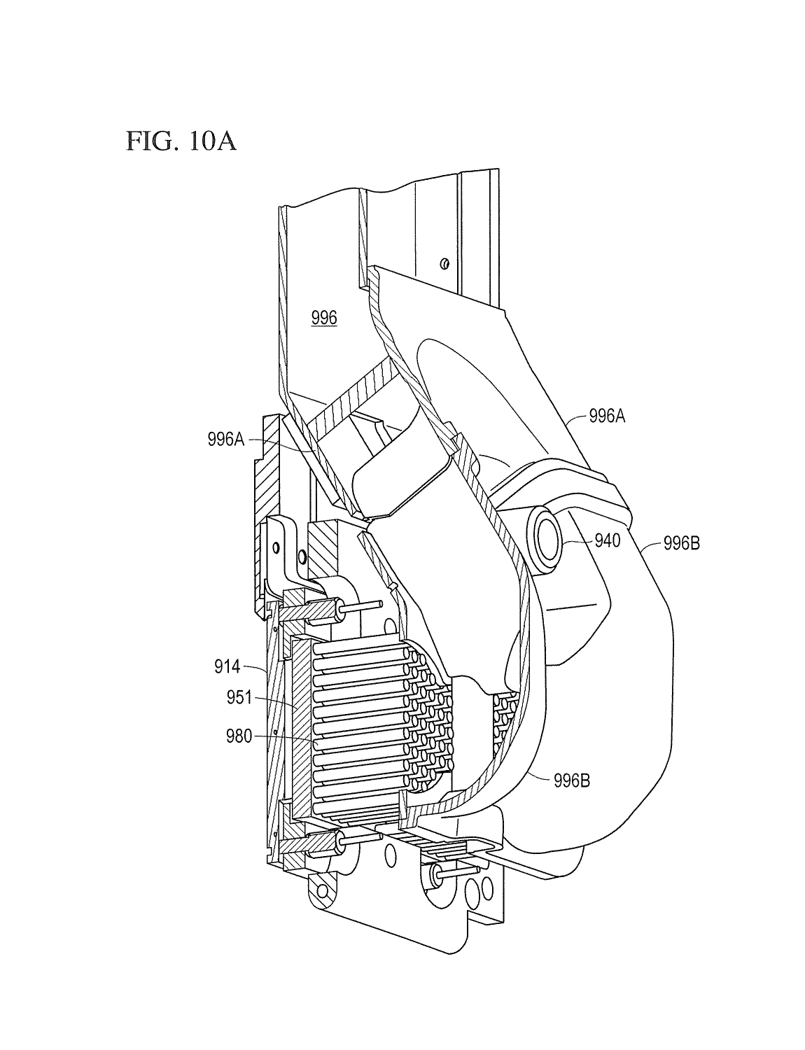

In various exemplary embodiments, for example, as schematically depicted in block diagram form in FIGS. 5-7, the cooling system 524, 624, 724 can comprise a heat sink 480 assembled with the thermoelectric device 360 and the sample block 112. The heat sink 480 may have a variety of differing configurations. In one embodiment, the heat sink 480 may comprise a substantially planar base (e.g., heat sink block) and fins extending from the base. In another embodiment, the heat sink 480 may be in the form of a plurality of pins, such as, for example, made of silver or other highly thermally conductive material (one embodiment of which is depicted in FIGS. 9 and 10). Those having ordinary skill in the art would understand various other heat sink configurations suitable for conducting relatively large amounts of heat away from the reaction chamber (including, e.g., samples and/or sample block 112) relatively quickly. Overall, it is desirable for the thermal mass of the heat sink to be considerably larger than the thermal mass of the sample block 112 and samples 110 combined. As a result, the sample block 112 may change temperature significantly faster than the heat sink 480 for a given amount of heat transferred by the heating system 156.

As shown in FIG. 5, according to an exemplary embodiment, a cooling system 524 can include a fan 590 and/or at least one other cooling member 592 configured to control the temperature of the heat sink 480. The fan 590 and/or the cooling member 592 can be operably controlled, for example, by the controller 120. According to some aspects, the fan 590 and/or the cooling member 592 can be operated to hold the heat sink 480 at approximately 45° C., which is well within the normal PCR cycling temperature range, or at approximately 0° C. to about 20° C. for imaging during sequencing and/or about 60° C. to about 100° C. for reaction stages (e.g., melting/reset, denaturation, etc.) during sequencing. In some aspects, maintaining a stable heat sink temperature can improve repeatability of system performance.

According to some exemplary embodiments, the cooling member 592 can be configured to lower the temperature of the ambient air being directed toward the heat sink 480 by a fan 590. As shown in FIG. 5, the cooling member 592 can lower the ambient air temperature by outputting a cooling fluid 594 such as, for example, CO₂ (bottled or dry), liquid nitrogen, pressurized air, a chilled gas (e.g., cold gas from liquid nitrogen), water, etc. into the airflow path of the fan 590.

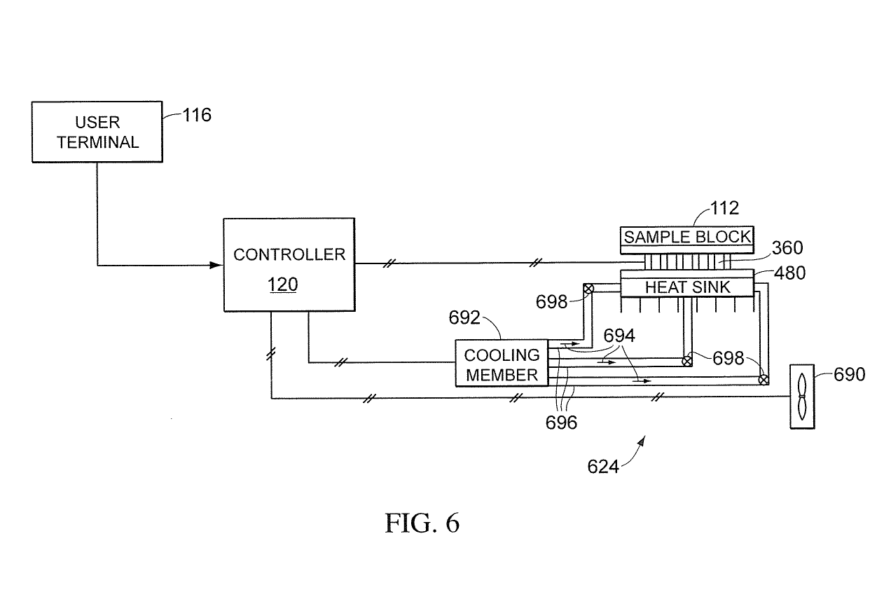

Referring now to FIG. 6, a cooling system 624 can comprise at least one cooling member 692 configured to output a cooling fluid 694, such as, for example, CO₂ (bottled or dry), liquid nitrogen, pressurized air, water, etc. to a series of plumbing 696 and valves 698 configured to direct the cooling fluid to one or more regions of the heat sink 480. According to some aspects, cooling system 624 can also include a fan 690 disposed to control the heat sink temperature.

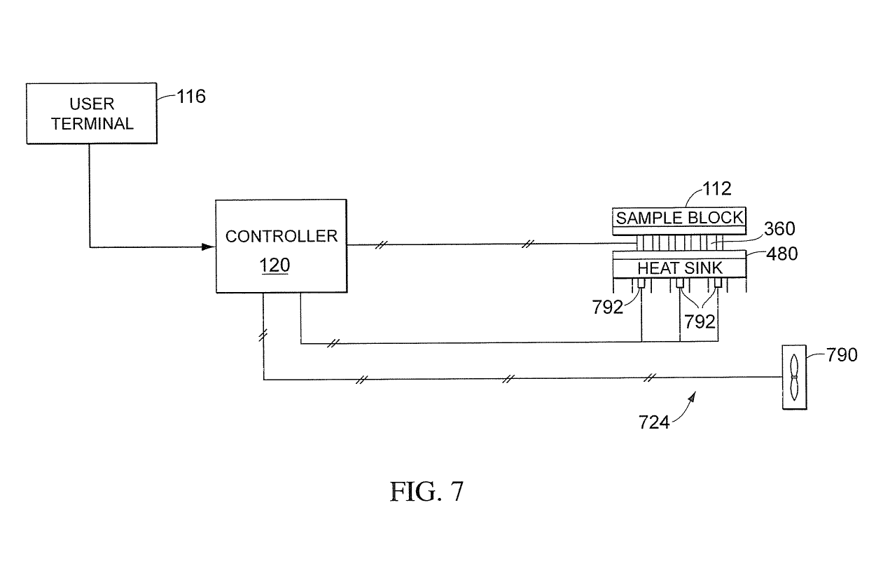

As shown in FIG. 7, according to various exemplary embodiments, a cooling system 724 can include one or more cooling members 792 configured to generate and/or direct cool air toward the heat sink 480 and/or to absorb heat from the heat sink 480. According to some aspects, one or more of the cooling members 792 can be mounted within cooling fins etc. associated with a region of the sample block 112 to cool that specific region, as discussed below. According to some aspects, cooling system 724 can also include a fan 790 to control the heat sink temperature.

Although the exemplary embodiments of FIGS. 5-7 show the use of a Peltier device 360 and heat sink 480, various other exemplary embodiments may include a cooling system comprising a cooling member that replaces the Peltier device and the heat sink. Further, in systems wherein direct circulation of fluid around the sample holders is used for heating and/or cooling, a cooling system having a cooling member may be used in lieu of or in addition to such fluid circulation.

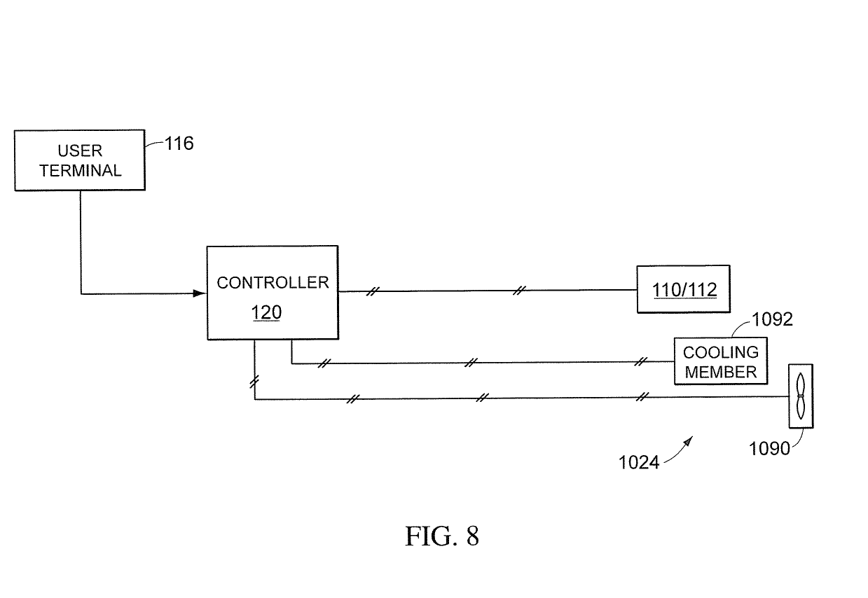

FIG. 8 depicts an exemplary embodiment of a cooling system 1024 comprising a cooling member 1092 and a conventionally disposed fan 1090. The cooling system 1024 may be configured to reduce the temperature of sample block 112 or of the sample 110 (e.g. sample holder and/or reaction chamber containing the sample) directly, that is, without a heat sink. The cooling member 1092 may thus be configured to output a cooling fluid such as, for example, CO₂ (bottled or dry), liquid nitrogen, pressurized air, water, etc., in a manner similar to one or more of the cooling members 592, 692, 792. The cooling system 1024 also may be used in conjunction with a heating system (not shown in FIG. 8), such as, for example, the heating systems described herein, configured for raising the temperature of the block 112 or the samples directly. It will also be appreciated by those having skill in the art that, in accordance with various exemplary embodiments, the cooling systems 1024 may be used as the heating system as well, depending, for example, on the type of cooling member 1092 that may be used.

Although the exemplary embodiments of FIGS. 5-8 illustrate a fan 590, 690, 790, or 1090 used in conjunction with the cooling systems 524, 624, 724, or 1024, such a fan need not be utilized, or alternatively, in some exemplary embodiments, the cooling member itself may comprise a fan disposed to direct air toward the heat sink 480, thermoelectric device 360 and/or reaction chamber containing the sample block 112, as will be explained in more detail below with reference to the exemplary embodiment of FIGS. 9 and 10.

The term “cooling member” as used herein refers to cooling components that differ from, augment, and/or modify conventional fan cooling arrangements and/or conventional fluid circulation arrangements which may include devices such as Peltier devices, fans, and/or fluid circulation systems currently that may be used for reducing the temperature of samples during a temperature protocol in biological analysis instrument devices and processes, including, for example, PCR thermal cycling devices and processes and flow cell sequencing devices and processes. The cooling systems discussed herein may utilize, adapt, or modify a conventional cooling mechanism such as a fan and include at least one component, modification, adaptation or arrangement other than a conventional mechanism used for cooling in such biological analysis instruments. It is contemplated that cooling members and systems used with exemplary embodiments of the invention may provide greater temperature control, improved efficiency, and/or improved heat transfer than the use of prior conventional cooling mechanisms, and/or may minimize undesired physical effects when compared to conventional cooling mechanisms.

With reference now to FIGS. 9 and 10, one exemplary embodiment of a portion of a biological analysis instrument that includes a flow cell is illustrated. As will be described in more detail below, FIG. 9 shows the instrument in an open position and FIG. 10 shows the instrument in a closed position, the position in which reactions and analysis typically occur.

Flow cells in accordance with exemplary embodiments of the present teachings may have a variety of forms and configurations. In general, flow cells may include any structure configured to define a reaction chamber to receive a biological sample for analysis and various flow control mechanisms to permit reagent and/or other substances from a source external to the flow cell into the reaction chamber to react with the biological sample contained in the reaction chamber. Those having skill in the art are familiar with various flow cell configurations. For further details regarding suitable flow cell arrangements, reference may be made to WO 2006/084132, U.S. Pat. Nos. 6,406,848 and 6,654,505, and PCT Publication No. WO 98/05330, which are incorporated by reference herein.

In one exemplary embodiment, a flow cell, such as the flow cells of FIGS. 9, 10, and 10A may be configured to support a substrate holding template DNA thereon, such as, for example, a microarray of synthesized templates supported on the substrate by a plurality of beads. It also is envisioned, however, that microtiter plates, capillaries, and/or other sample holders configured to be filled with one or more biological samples may be supported by the sample blocks in the flow cells. Further, it also is envisioned that one or more biological samples may be introduced directly into the reaction chamber of the flow cell without being held by a substrate, microtiter plate, and/or other sample holder. In one exemplary embodiment of an arrangement wherein the sample is introduced into the reaction chamber without a sample holder, the sample block may also be removed and the reaction chamber itself formed by the flow cell structure being heated and cooled. Moreover, in an exemplary embodiment, the flow cells may be configured to flow reagents into the reaction chambers to react with the microarrays in order to perform sequencing of the template DNA residing on the substrate. Examples of various substrates holding DNA templates and methods of making such substrates can be found in WO 2006/084132, which published Aug. 10, 2006, entitled “REAGENTS, METHODS, AND LIBRARIES FOR BEAD-BASED SEQUENCING,” and is incorporated herein by reference in its entirety. WO 2006/084132 also provides details on flow cell devices that may be used in conjunction with the various cooling systems of the present teachings and on various methods and devices useful for performing sequencing of biological samples.

Although the dual flow cell arrangement shown in the exemplary embodiment of FIGS. 9 and 10 may be particularly suitable for receiving a substrate holding one or more biological samples for analysis, it should be understood that flow cells in accordance with various exemplary embodiments of the present teachings may define reaction chambers configured to directly receive one or more samples for biological analysis and/or to receive various types of sample holders as have been described herein containing one or more biological samples. Moreover, those having ordinary skill in the art would recognize that the flow cells in accordance with various embodiments of the present teachings may be configured to perform various biological analyses and reaction processes therein, including, but not limited to, for example, nucleic acid analysis methods, such as, for example, sequencing and/or hybridization assays, protein analysis methods, binding assays, screening assays, and/or synthesis, for example, to generate combinatorial libraries, and/or other biological processes and analysis methods.

A dual flow cell arrangement such as that illustrated in the exemplary embodiment of FIGS. 9 and 10 also may permit one flow cell to be imaged while other process steps such as, for example, extension, ligation, and/or cleavage, are being performed in another flow cell. This may maximize utilization of the optical system while increasing throughput. Further, a dual flow cell arrangement may permit the processing and/or analysis of differing samples to occur. It should be understood, however, that any number of flow cells may be provided, with the dual embodiment of FIGS. 9 and 10 being exemplary and nonlimiting.

The exemplary embodiment of a biological analysis instrument of FIGS. 9 and 10 forms a dual flow cell arrangement situated on a common translation stage 951 and includes two sample blocks 912 each fitted with gaskets 915 on an upper surface thereof, which may be in the form of rubber O-rings, for example. Those having skill in the art would recognize that the gaskets 915 may be any of a variety of mechanisms useful for forming a seal. The gaskets 915 may be configured to engage with a cover 914 such that, when the instrument is in the closed position, as in FIG. 10, reaction chambers are formed within the respective spaces defined by the blocks 912, the gaskets 915, and the cover 914.

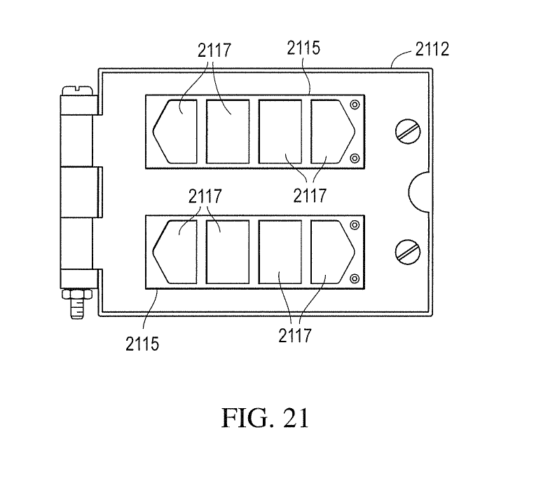

In various exemplary embodiments, partitioned gasket arrangements may be used such that within each flow cell a plurality of segregated reaction chambers are formed. FIG. 21 illustrates an exemplary embodiment of a dual flow cell wherein a sample block 2112 is provided with two partitioned gaskets 2115. Although a single sample block 2112 is shown in FIG. 21, a separate sample block for each gasket 2115 also may be utilized, similar to the configuration illustrated in FIG. 9. Each of the partitioned gaskets 2115 is configured to define four separate reaction chambers 2117 when a cover (e.g., like cover 914 in the exemplary embodiment of FIGS. 9 and 10) mates with the partitioned gasket 2115. In this way, a different or the same biological sample may be introduced into each reaction chamber 2117, along with differing or the same reagent mixtures and/or other reaction mixtures, to support the same or differing reactions in each reaction chamber 2117. A partitioned gasket 2115 may therefore provide flexibility in the reaction processes occurring in each flow cell. Those having skill in the art would recognize a variety of configurations for the partitioned gasket 2115, with the arrangement shown in FIG. 21 being nonlimiting and exemplary only. For example, a partitioned gasket in accordance with the present teachings may be configured to create any plural number of reaction chambers. Moreover, each of the reaction chambers 2117 may be provided with separate inlet and outlet ports (not shown) to facilitate flowing differing reagents, biological samples, and/or other substances into each reaction chamber 2117.

With reference again to FIGS. 9 and 10, the cover 914 may define two openings 917 therein that are covered with a transparent material, such as, for example a glass or plastic material or other suitable transparent composition. The openings 917 are configured to substantially align with each of the sample blocks 912 when the instrument is in the closed position to perform optical detection and/or imaging of the flow cell reaction chambers. Various optical detection and imaging systems may be used (components of which are not illustrated) and may be positioned external to the cover 914 to detect and gather, for example, in real-time, images of reactions and samples in the reaction chambers through the openings 917. For details regarding an exemplary detection and imaging system that may be used in conjunction with the biological instrument in FIGS. 9 and 10, reference is made to WO 2006/081432, incorporated by reference herein.

In the closed position shown in FIG. 10, the bottom portion of the instrument is brought into a substantially vertical orientation such that the cover 914 engages with the gaskets 915 to form substantially sealed reaction chambers in which sample reaction and/or analysis may occur. A closure mechanism 940, which may be in the form of a rotatable screw, may be used to keep the instrument in the closed position. The closure mechanism 940 may provide a clamping force sufficient to keep the heater blocks 912 pressed against substrates (e.g., microscope slides) positioned within the reaction chambers. As shown, in the exemplary embodiment of FIG. 10, the closed position orients the reaction chambers substantially vertically. Such an orientation may have advantages during biological reaction and/or analysis (e.g., including detection and/or imaging). For example, by orienting the reaction chambers vertically, gas (e.g., air) bubbles that may be formed in the reaction chamber may flow to the top of the chamber and exit an output port positioned toward the chamber top, permitting gravimetric bubble displacement. For further details regarding advantages of substantially vertically oriented flow cell instruments, reference is made to WO 2006/084132, incorporated by reference herein. It should be understood, however, that the flow cells may have orientations other than vertical during reaction and analysis. Those skilled in the art would understand various modifications could be made to provide a flow cell in another orientation without departing from the scope of the present teachings.

The reaction chambers of each flow cell are configured to hold one or more biological samples for analysis that may be provided in a variety of differing types of sample holders to be supported by each of the blocks 912. By way of example, the blocks 912 may support a substrate, such as, for example, a substantially planar microscope slide, having a plurality of microparticles (e.g., DNA templates) arranged thereon). Various reagents and/or other substances configured to react with the one or more samples present in the reaction chamber may be introduced and removed from the reaction chambers, thereby forming the flow cells. Various flow control mechanisms, including but not limited to, for example, ports, piping, conduits, valves, and/or other flow control devices (not shown in FIGS. 9 and 10), may flow various reagents and/or other substances into and out of the reaction chambers. Those having skill in the art would understand how such flow control mechanisms may be configured and disposed to flow substances into and out of the reaction chambers.

The sample blocks 912 in the exemplary embodiment of FIGS. 9 and 10 may be made of a material that has a relatively high thermal conductivity. In various exemplary embodiments, the sample blocks 912 may be stainless steel, lapped on one side and passivated. Other suitable materials for the sample blocks 912 include, but are not limited to, for example, silver, aluminum, copper, and/or various alloys and/or other metals.

The biological analysis instrument of FIGS. 9 and 10 also includes a thermal system configured to control a temperature of the biological samples to maintain the sample at or within a range sufficient for performing a desired reaction or process. In the exemplary embodiment of FIGS. 9 and 10, a heating system may comprise a Peltier thermoelectric device 960 underlying the sample block 912 and configured to raise the temperature of the blocks 912 and thus the sample supported by the sample blocks 912. In various embodiments the peltier may comprise a single device that heats both blocks or may be configured as separately controllable units. In various embodiments the peltier may be configured with multiple zones capable of heating/cooling substantially independently for each zone. In still other configurations, the peltier may be configured as a segmented device capable of separately controlled/configurable heating and cooling arrangements.

Provided in thermal communication with the thermoelectric device 960 is a heat sink 980, which is shown in the cut-away cross-sectional view of FIG. 10A. The heat sink 980 may be in the form of a plurality of heat conducting pins, made, for example, of silver or other suitable material exhibiting relatively high thermal conductivity. The heat sink 980 may be placed in thermal communication with the thermoelectric device 960 via a heat sink compound, such as, for example, a heat conducting foil impregnated with thermal grease. The heat sink configuration may additionally comprise alternative arrangements such as for example inclusion of a fluid layer or other arrangements as will be appreciated by one of skill in the art. It should be understood that the heat sink 980 illustrated in FIGS. 9, 10, and 10A illustrates one embodiment of a suitable configuration useful in the biological instrument shown. Such a configuration is nonlimiting and exemplary and other heat sink configurations may be used to transfer heat away from the flow cell and sample therein. Those skilled in the art would recognize a variety of differing heat sink configurations that may be used for transferring heat away from the flow cells of FIGS. 9 and 10.

In accordance with an exemplary aspect of the present teachings, the biological analysis instrument of FIGS. 9 and 10 includes a novel cooling system that includes a cooling member in the form of a distally located fan 992. The fan 992 is in flow communication with a network of ducts 995, 996, 996A, and 996B such that a cooling fluid that may include, for example, air) blown by the fan 992 travels through the ducts 995, 996, 996A, and 996B and to the proximity of the flow cells. More specifically, as can perhaps best be seen in FIG. 10A, the fan 992 (not shown in FIG. 10A) is configured to deliver an air stream through the ducts 995, 996, 996A, and 996 such that the air turns up and over the heat sink 980 and then flows down into the openings between the pins of the heat sink 980 to provide cooling to the reaction chambers of the flow cells and sample therein.

In the exemplary embodiment of FIGS. 9 and 10, the fan 992 may include a centrifugal blower mounted to a base plate that in turn is mounted to a plate 993 defining an opening 994 configured for an axial fan. Using a centrifugal blower for the fan 992 may provide a greater back pressure as compared to an axial fan, thereby transferring air efficiently through the relatively long, narrow duct passages 995, 996, 996A, and 996B to the heat sink 980. The opening 994 serves as an entrance for air and the fan 992 sucks ambient air in through the opening 994 through an elbow 991, and into ducts 995 and 996. In the exemplary embodiment of FIGS. 9 and 10, the fan 992 may be located at a distal location substantially above the biological analysis instrument. However, it should be understood that the fan 992 may be positioned in other distal locations as well and connected via ductwork so as to blow a sufficient amount of air to the heat sink 980 to provide cooling. By way of example only, the fan 992 may have a capacity of greater than about 50 cfm, for example, in a range from about 65 cfm to about 70 cfm. For example, the fan may be a model no. MD10-24 fan supplied by Oriental Motors. Those having skill in the art would understand that a variety of fans may be used as the fan 992 and may be selected depending on factors such as, for example, space limitations, desired volumetric airflow (e.g., capacity), noise level, and other factors.

The distally located (e.g., remotely located) fan 992 is positioned at a sufficient distance from other portions of the biological analysis instrument, such as, for example, the flow cells and heat sink, such that physical effects of the fan 992 on the flow cell reaction chambers are minimized, for example, as compared to conventional flow cell cooling systems in which one or more fans are disposed proximate the flow cell reactions chambers, for example, in contact with a heat sink that underlies the reaction chamber. In various exemplary embodiments, the distal positioning of the fan 992 is such that movement of the fan 992 does not cause substantial physical movement, such as, for example, vibration, of the flow cell reaction chambers. In this way, optical detection and imaging may be optimized for accuracy. Moreover, the distal positioning of the fan 992 may reduce other undesired heat transfer effects on the reaction chambers, such as, for example, caused by hot air exhaust, condensation, and the like.

By positioning the fan 992 at a distal location from the reaction chambers in FIGS. 9 and 10, a larger capacity fan may be used, for example, in comparison to the fans used in the cooling arrangements of FIGS. 1 and 2. In one exemplary embodiment, the capacity of the fan 992 may be greater than about 50 cfm, for example, from about 65 cfm to about 70 cfm.

In the open position shown in FIG. 9, it can be seen that duct portions 996B are situated on an opposite side of the heat sink 980 and define openings that are configured to mate with duct portions 996A. FIG. 10 illustrates the duct portions 996A and 996B in a mating engagement when the instrument is in the closed position. The mating arrangement permits air from the fan 992 to flow through duct 995, into duct 996 and from duct 996 into ducts 996A and 996B to the heat sink 980. Various latching mechanisms, such as the rotatable member 940, may be used to keep the biological analysis instrument in the closed position depicted in FIG. 10. Those having skill in the art would understand how to select suitable latching mechanisms.

A switch may also be provided and configured to be activated in response to movement of the movable lower portion (e.g., door) of the biological analysis instrument. The movable lower portion is that portion, which includes the ducts 996B, that moves from the closed position in FIG. 10 to the open position of FIG. 9. The switch may be electrically connected to the fan 992 so that when the biological instrument is moved from the closed position to the open position (e.g., the ducts 996A and 996B are removed form their mating engagement), the switch cuts of power to the fan 992. This prevents air from the fan 992 from being circulated through the ducts 996A and out of the openings of those ducts, which could cause any sample supported on the blocks 912, either on a sample holder or otherwise, to dry. In an alternative arrangement, the switch may be configured to change the state of a damper or the like, for example, positioned in duct 996, to block air from the fan 992 from entering the ducts 996A and 996B.

Further, the same or a different switch also may be used to cut off power to the thermoelectric device 960 when the biological analysis instrument is placed in the open position, for example, by opening the circuit to the thermoelectric device or by changing a state of the controller that powers the thermoelectric device. It may be desired to terminate operation of the thermoelectric device when the instrument is in the open position to prevent the device from continuing to heat without the circulation of air flow through the ducts 996A and 996B.

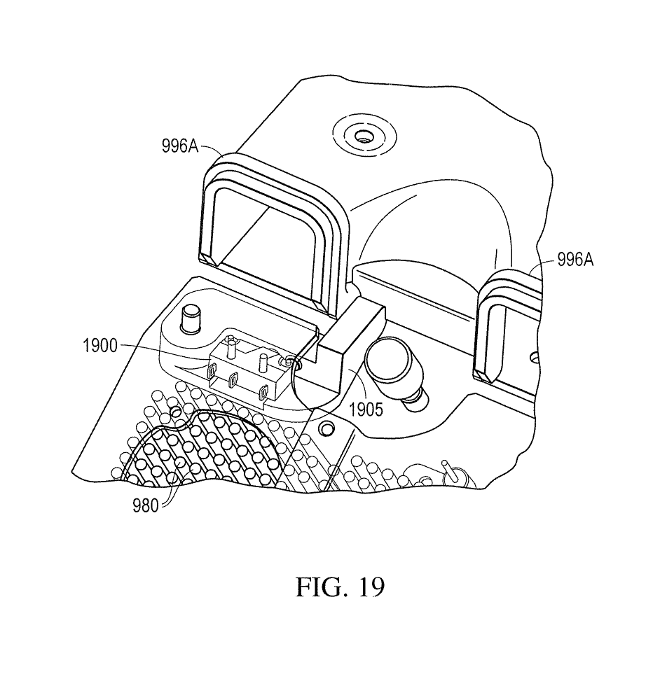

FIG. 19 shows a partial cut-away view of the biological analysis instrument of FIGS. 9 and 10 provided with a switch 1900. An operating arm 1905 may be spring-biased in an outward position. The operating arm 1905 may be configured and located such that when the lower portion of the flow cell instrument is moved into the closed position, the operating arm 1905 is depressed, which compresses the spring biasing it outward and depresses a plunger of the switch, and thereby closes the circuit that operates the fan 992 and/or thermoelectric device 960. When the lower portion of the flow cell device is moved to the open position, as shown in FIG. 9, the arm 1905 moves outwardly away from a plunger of the switch 1900, which breaks a circuit that provides power to the fan 992 and the thermoelectric device 960.

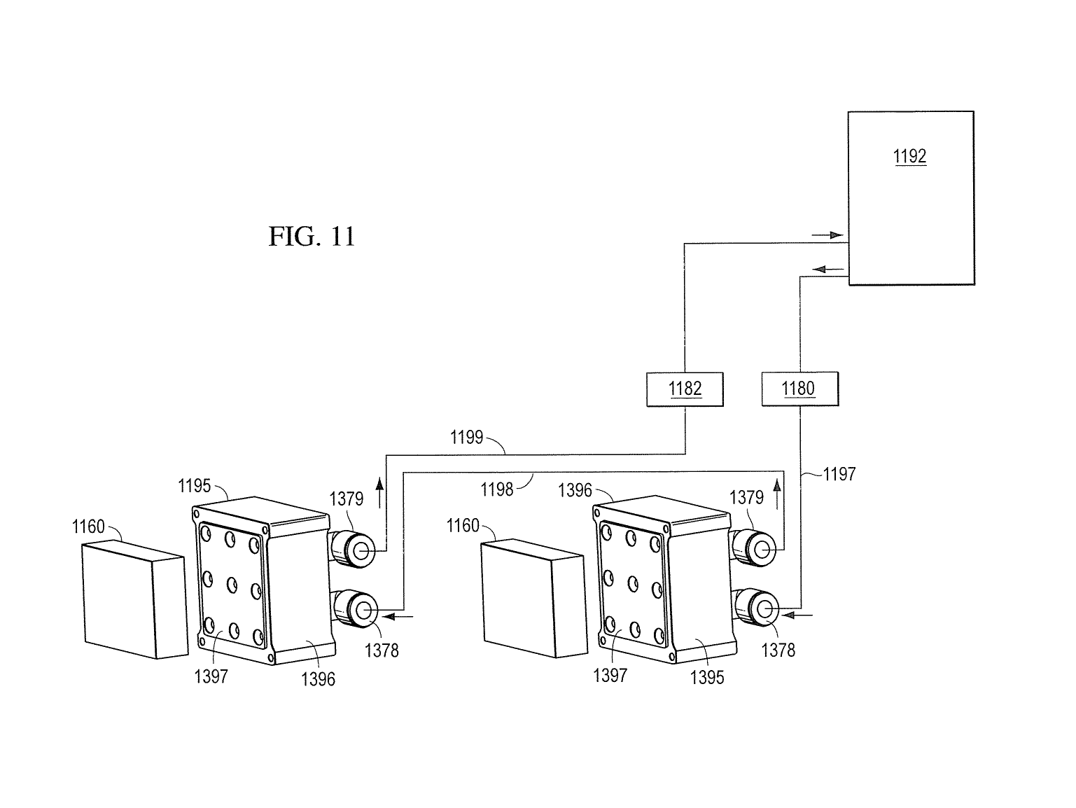

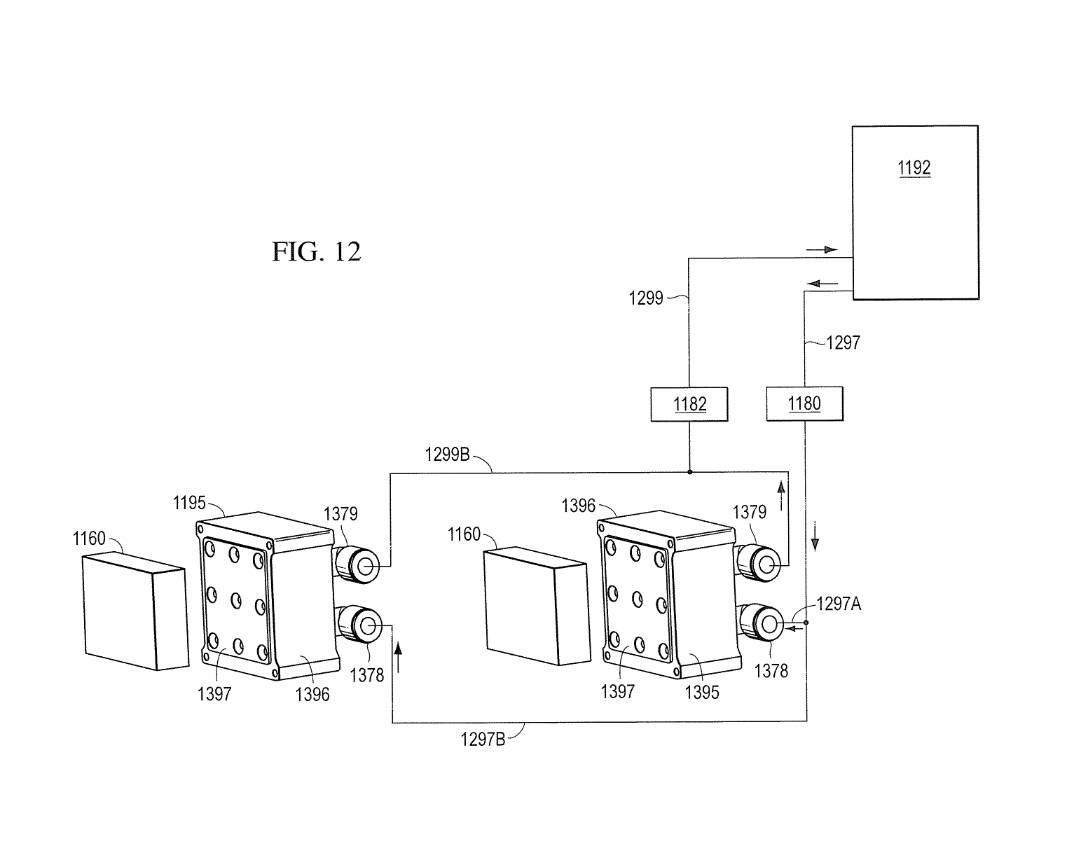

FIGS. 11 and 12 schematically depict exemplary embodiments of a cooling system that may be used in conjunction with a biological instrument similar to that in FIGS. 9 and 10. In lieu of the distally located fan 992, ducts 995, 996, 996A, and 996B, and heat sink 980 shown in FIGS. 9 and 10, the exemplary embodiments of FIGS. 11 and 12 use a cooling system that includes a cooling member in the form of a recirculating chiller 1192 configured to circulate a cooling fluid through a network of flow control mechanisms, described in more detail below, and into one or more cooling modules 1195 that are placed in thermal communication with one or more flow cells or other components of a biological analysis instrument to be cooled.

Various cooling fluids may be circulated by the chiller and through the cooling modules 1195. By way of example only, suitable cooling fluids may include, but are not limited to, for example, ethylene glycol, propylene glycol, methanol, water, antifreeze agents, and/or any combination thereof. In various embodiments the cooling fluid may be cooled within the recirculating chiller, a refrigeration cycler, or via heat exchange configurations.

In one exemplary embodiment, the cooling module 1195 may be configured to be placed in thermal communication with a thermoelectric device 1160 that is in turn in thermal communication with the flow cells, for example, in a manner similar to that described above with reference to the exemplary embodiments of FIGS. 9 and 10.

The exemplary embodiments of FIGS. 11 and 12 may be configured to provide cooling to a dual flow cell arrangement of a biological analysis instrument such that each cooling module 1195 respectively provides cooling to each of the flow cells in the dual flow cell arrangement. More specifically, each cooling module 1195 may be in thermal communication with a side of the thermoelectric device 1160 disposed opposite to the side in contact with each flow cell.

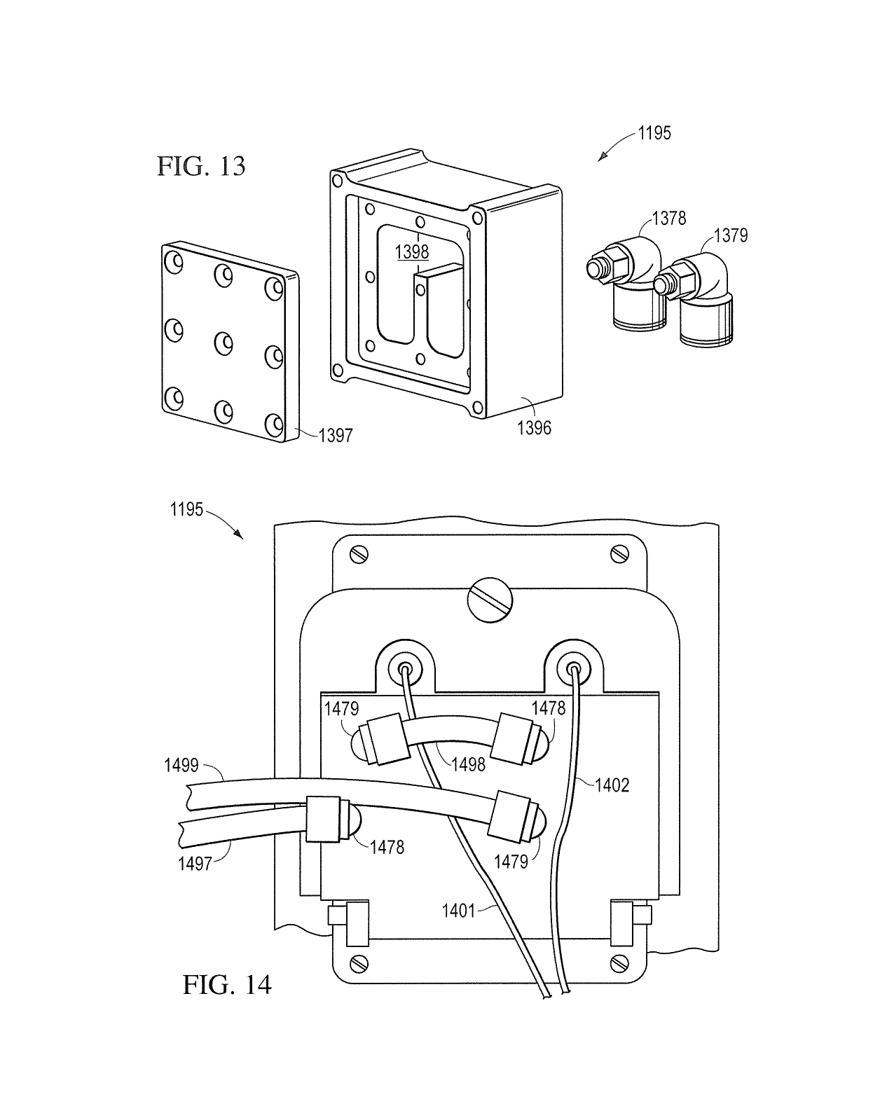

FIG. 13 schematically illustrates an isometric view of an embodiment of a cooling module 1195. As shown, the cooling module 1195 may include a housing 1396 defining a chamber 1398. The chamber 1398 may be placed in flow communication with ports 1378 and 1379 configured for either input or output of the recirculating cooling fluid of the cooling system, as will be described in more detail below. The housing 1396 may be open on a face opposite to the ports 1378 and 1379 and the cooling module 1195 also may include a plate 1397 configured to cover the opening and the chamber. To provide cooling, the recirculating cooling fluid may enter into the chamber 1398 via one of the ports 1378 or 1379, circulate therein, and exit out of the chamber 1398 via the other port 1378 or 1379. While in the chamber 1398, the cooling fluid may cool the plate 1397, which may in turn cool the thermoelectric device 1160 and thereby the corresponding reaction chamber.

In one exemplary embodiment, the recirculating chiller 1192 may comprise a centrifugal pump configured to pump cooling fluid through the network of pipes to the cooling modules 1195. Because a centrifugal pump is pulseless, use of such a pump may minimize vibrations and other movement associated with the cooling system, thereby minimizing undesired physical effects of the cooling system on the biological analysis instrument. Further, the recirculating chiller 1192 may be placed distally from the reaction chamber to further minimize physical effects, including undesired movement and/or exhaust heat and/or condensation of the cooling system on the reaction chamber. In various exemplary embodiments, the recirculating chiller 1192 may be placed several feet away from the biological analysis instrument's reaction chamber or chambers, and may expel exhaust heat generated by the chiller 1192 outside an enclosure housing the instrument.

Additionally, in accordance with various exemplary embodiments, a recirculating chiller cooling system, including those schematically represented in FIGS. 11 and 12 and shown in conjunction with a flow cell in FIG. 14, may have a relatively high cooling capacity, for example, about 210 watts of cooling capacity. This relatively high cooling capacity may permit a thermoelectric device in thermal communication with the cooling module to achieve lower temperatures and ramp more quickly between incubation temperatures, thereby increasing the overall efficiency and throughput of a biological analysis instrument, such as, for example, a flow cell.

FIGS. 11 and 12 illustrate two exemplary embodiments of how the recirculating chiller 1192 may be placed in flow communication with the cooling modules 1195 to circulate cooling fluid therethrough. The recirculating chiller 1192 connects to the cooling modules 1195 to supply cooling fluid thereto in a series arrangement in FIG. 11 and in a parallel arrangement in FIG. 12.

Thus, in the exemplary embodiment of FIG. 11, cooling fluid flows from the recirculating chiller 1192 in the direction of the arrow shown through a conduit 1197 and into an inlet port 1378 of the first cooling module 1195 in the series arrangement. From the first cooling module 1195, the cooling fluid flows through an outlet port 1379 and into a conduit 1198 which connects to the inlet port 1378 of the second cooling module 1195. The cooling fluid exits the second cooling module 1195 via an outlet port 1379 and into a return conduit 1199 that is in flow communication with the recirculating chiller 1192 to return the cooling fluid back to the recirculating chiller 1192 in the direction of the arrow shown.

In FIG. 12, the cooling fluid flows from the recirculating chiller 1192 in the direction of the arrow shown and into a flow conduit 1297. The flow conduit 1297 branches to two separate flow conduits 1297A and 1297B. Branch flow conduit 1297A flows the cooling fluid into the inlet port 1378 of one of the cooling modules 1195 and branch conduit 1297B flow the cooling fluid into the inlet port 1378 of the other cooling module 1195. From each of the cooling modules 1195, the cooling fluid exits via outlet ports 1379 and into two separate branch conduits 1299A and 1299B. Eventually, branch conduits 1299A and 1299B join together to deliver the cooling fluid to a single conduit 1299 that flows the cooling fluid back to the recirculating chiller 1192 in the direction of the arrow shown.

Valves 1180 and 1182 may be provided in each of the conduits 1197 and 1297, and 1199 and 1299, respectively, to modulate the flow of the cooling fluid to and from the recirculating chiller 1192. The various flow conduits 1197, 1198, 1199, 1297, 1297A, 1297B, 1299, 1299A, and 1299B may be configured as any suitable flow structure, such as, for example, a tube, pipe, or the like. Suitable materials from which the flow conduits may be made include materials exhibiting insulating properties, and include, for example plastic, glass, suitable metal, or other composition.

With reference now to FIG. 14, a partial plan view of an exemplary embodiment of a biological analysis instrument in the form of a flow cell that includes a cooling system comprising a recirculating chiller and cooling module arrangement as described above is shown. In the exemplary embodiment of FIG. 14, a vertically oriented dual flow cell arrangement 1400 is shown in a closed position from the support side (e.g., the side that faces away from the reaction chambers of the flow cells). The flow cell includes flow tubes 1401 and 1402 configured to introduce to and remove from the flow cells various reagents and/or other substances desired to support a reaction inside the reaction chambers. Cooling modules (not shown in FIG. 14) like cooling modules 1195 shown in FIGS. 11-13 are placed in thermal communication with one or more thermoelectric devices (also not shown) used to control a temperature of the flow cells. The cooling system may include a recirculating chiller (not shown) similar to recirculating chiller 1192 that is connected in series to the cooling modules. Thus, a cooling fluid may enter a first cooling module through a tube 1497 and corresponding input port 1478. From the first cooling module, the cooling fluid may exit through an outlet port 1479 and enter a tube 1498 that flows the fluid into the inlet port 1478 of the second cooling module. From the second cooling module, the cooling fluid may flow through the outlet portion 1479 and into the tube 1499 to return to the recirculating chiller.

Valves and additional flow control mechanisms also may be provided in the cooling system of FIG. 14 to control the flow of the recirculating cooling fluid. Those having ordinary skill in the art would recognize various modifications of the overall flow control network without departing from the scope of the invention.

In an alternative exemplary embodiment, the thermoelectric device may be removed and the cooling modules 1195 may be placed so as to directly act on the sample block. By controlling the temperature of the fluid circulating through the modules 1195, the temperature of the blocks and reaction chambers may be controlled, for example, both heated and cooled via the circulating fluid.

Various other cooling members may be used in conjunction with biological analysis instruments, including, for example, flow cells as discussed with reference to the exemplary embodiments of FIGS. 9, 10 and 14. Such cooling members may provide at least some of the desired features and aspects discussed herein. That is, various cooling members, as set forth in more detail below, may be used to achieve greater and more efficient cooling of the sample block and/or reaction chamber (including the samples and/or a sample holder in the chamber) of a biological analysis instrument. Further, various cooling members, as discussed in more detail below, may serve to minimize undesired physical effects, including, but not limited to, undesired heat transfer effects, vibration, and/or other physical movement, on the reaction chamber and/or other sensitive components of a biological instrument.

According to various exemplary embodiments, the cooling member 592, 692, 792, 1092 may include, but is not limited to, one of several types of cooling components described in more detail below. As mentioned above, the various cooling members described below may be used alone, in combination with conventional cooling mechanisms, such as, for example, conventional fan arrangements and/or Peltier devices, and/or in combination with one or more of the various other cooling members described below.

According to some exemplary aspects, the cooling member 592, 692, 792, 1092 can comprise one or more synthetic jet ejector arrays (SynJets), for example, as described in U.S. Pat. No. 6,588,497, which is incorporated herein by reference in its entirety. SynJets, developed at the Georgia Institute of Technology and licensed to Innovative Fluidics, can be more efficient than conventional fan cooling. For example, SynJets can produce two to three times as much cooling with two-thirds less energy input. The SynJets comprise modules having a diaphragm mounted within a cavity having at least one orifice. Electromagnetic or piezoelectric drivers cause the diaphragm to vibrate 100 to 200 times per second, rapidly cycling air into and out of the module and creating pulsating jets that can be directed to precise locations where cooling is needed. According to various aspects, the modules can be mounted directly within the cooling fins or other structures of the heat sink 480. Alternatively, the SynJet modules could be placed proximate, but not coupled to, the heat sink 480.

When used with a biological analysis instrument in the form of a flow cell, which may have any of the configurations in accordance with the present teachings, a SynJet array may be placed either proximate the flow cell, such as coupled or proximate a heat sink in thermal communication with the flow cell, or at a distal location remote from the flow cell. In either location, it is expected that such a cooling member may minimize physical effects on the flow cell reaction chamber, such as, for example, vibration, exhaust heat, and/or condensation, as compared to a conventional cooling system for a flow cell wherein a fan is mounted to the heat sink.

According to various exemplary aspects, the cooling member 592, 692, 792, 1092 can alternatively or additionally comprise one or more vibration-induced droplet atomization (VIDA) devices, also developed at the Georgia Institute of Technology and licensed to Innovative Fluidics. VIDA devices use atomized liquid coolants, for example water, to carry heat away from desired components. Piezoelectric actuators are used to produce high-frequency vibration to create sprays of tiny cooling fluid droplets inside a closed cell attached to an electronic component, for example, the heat sink 480, in need of cooling. The droplets form a thin film on the hot surface, for example, a hot surface associated with the heat sink 480, the metal block 112, or the sample holders, thereby allowing thermal energy to be removed by evaporation. The heated vapor then condenses, and the liquid is pumped back to the vibrating diaphragm for re-use. U.S. Pat. No. 6,247,525, incorporated herein by reference in its entirety, discloses exemplary embodiments of VIDA devices.

When using such a cooling member in conjunction with a biological analysis instrument that includes one or more flow cells, as have been described herein, a VIDA device may be attached directly or proximate the heat sink. Vibrations and other movement of the flow cell reaction chamber caused by such a VIDA-based cooling system is less than that of the conventional fan arrangement depicted in FIGS. 1 and 2.

According to some exemplary aspects, the cooling member 592, 692, 792, 1092 can comprise a piezo fan. A piezo fan can be a solid state device comprising a compound piezo/stainless steel blade mounted to a PCB mount incorporating a filter and a bleed resistor. DC voltage can be delivered to an inverter drive circuit, which delivers a periodic signal to the fan that matches the resonant frequency of the fan, causing oscillating blade motion. The blade motion creates a high velocity flow stream from the leading edge of the blade that can be used to cool a heated surface, for example, the fins 486 of the heat sink 480, the metal block 112, or the surface of the sample holders. Piezo fans that may be utilized as the cooling member 592, 692, 792 can include, for example, those marketed by Piezo Systems, Inc. Piezo fans also may be used in conjunction with cooling the heat sink of a flow cell, and are again configured to reduce undesired physical effects on the flow cell, such as the vibration and/or heat effects discussed herein.

According to various exemplary aspects, the cooling member 592, 692, 792, 1092 can comprise one or more Cold Gun Aircoolant Systems™, such as those marketed by EXAIR®. The Cold Gun uses a vortex tube, such as those marketed by EXAIR®, to convert a supply of compressed air into two low pressure streams—one hot and one cold. The cold air stream can be muffled and discharged through, for example, a flexible hose, which can direct the cold air stream to a point of use, for example, in the path of airflow from the fan 590, 690, 790, 1090 to a heated surface such as, for example, the fins 486 of the heat sink 480 or other heat sink, such as heat sink 980, the metal block (e.g., sample block), or the surface of the sample holders. Meanwhile, the hot air stream can be muffled and discharged via a hot air exhaust.

When used as a cooling member for cooling a biological analysis instrument in the form of a flow cell, the Cold Gun may be placed either proximate or distal to the flow cell. Also, the Cold Gun may be used along with a distally located fan, as set forth in the exemplary cooling system of FIGS. 9 and 10. Use of Cold Gun cooling technology for cooling a flow cell, either alone or in conjunction with a distally located fan cooling system, may minimize physical effects on the flow cell reaction chamber in accordance with the present teachings since the Cold Gun provides relatively high capacity cooling without causing significant motion (e.g., vibration) and/or undesired heating effects, such as, for example, expelling exhaust heat.

According to some exemplary aspects, the cooling member 592, 692, 792, 1092 can comprise one or more microchannel cooling loops, such as, for example, those marketed by Cooligy for use with high-heat semiconductors. An exemplary cooling loop can comprise a heat collector defined by fine channels, for example, 20 to 100 microns wide each, etched into a small piece of silicon, for example. In some embodiments, the channels can be configured to carry fluid that absorbs heat generated by a hot surface such as, for example, the heat sink 480 or other heat sink, the sample block 112, and/or the sample holders. In some embodiments, the cooling loops can be configured to absorb heat from the ambient air in the path of airflow from the fan 590, 690, 790, 1090. The fluid passes a radiator, which transfers heat from the fluid to the air, thus cooling the fluid. The cooled fluid then returns to a pump, for example, an electrokinetic pump, where it is pumped in a sealed loop back to the heat collector.

As with the Cold Gun technology, the microchannel cooling loops also may be used in conjunction with a flow cell, such as, for example, the dual flow cell arrangements of the exemplary embodiments of FIGS. 9 and 10 or 14. The microchannel cooling loops may be used alone or in combination with another cooling member to cool the flow cell, e.g., to cool the thermoelectric device and/or a heat sink in thermal communication with the reaction chamber of the flow cell. In one exemplary embodiment, the cooling loops may be placed to cool air in the air path of the distal fan 992 of FIGS. 9 and 10. The cooling loops may be placed proximate the flow cell in an exemplary embodiment to provide cooling thereto (e.g., to cool a heat sink, a thermoelectric device, and/or the sample block or holder). As with other cooling members discussed herein, the cooling loops may minimize undesired physical effects of the cooling system on the reaction chamber of a flow cell or other biological analysis instrument.

According to various exemplary aspects, the cooling member 592, 692, 792, 1092 can comprise one or more Cool Chips™, such as those marketed by Cool Chips plc. The Cool Chips™ use electrons to carry heat from one side of a vacuum diode to another. As such, Cool Chips™ are an active cooling technology, which can incorporate passive cooling components, such as the fan 590, 690, 790, 1090. A Cool Chip layer can be disposed between the heating system 156 and the heat sink 480 to introduce a gap between the heating system 156 and the heat sink 480 or between the heating system and the metal block 112 or sample holders. By addition of a voltage bias, electrons can be encouraged to move in a desired direction, for example, from the heating system 156 to the heat sink 480, while their return to the heating system 156 is deterred by the gap. Thus, the heat sink 480 can be hotter without damaging the heating system 156. In some aspects, one or more Cool Chips can be arranged to absorb heat from ambient air to thereby cool the system.

Cool Chips also may be used to provide cooling to a flow cell, such as, for example, the dual flow cell arrangements of the exemplary embodiments of FIGS. 9 and 10 or 14. The Cool Chips may be used alone or in combination with another cooling member to cool the flow cell, e.g., to cool the thermoelectric device and/or a heat sink in thermal communication with the reaction chamber of the flow cell. In one exemplary embodiment, the Cool Chips may be used in conjunction with the distal fan 992 of FIGS. 9 and 10 or with the recirculating chiller cooling member of FIGS. 11-14. The cooling loops may be placed proximate a flow cell in an exemplary embodiment to provide cooling thereto (e.g., to cool a heat sink, a thermoelectric device, and/or the sample block or holder). As with other cooling members discussed herein, the cooling loops may minimize undesired physical effects of the cooling system on the reaction chamber of a flow cell or other biological analysis instrument.

According to various exemplary aspects, the cooling member 592, 692, 792, or 1092 may utilize heat pipe technology to conduct and/or remove heat. Heat pipes may have relatively high thermal conductivity (e.g., over one thousand times more conductive than copper) and a relatively flexible configuration to be capable of adapting to various physical environments. Due to such high thermal conductivity, heat pipe technology may reduce the delay between the heating/cooling source (e.g., Peltier device 360 and heat sink 480) or a resistive heater (not shown) and the load (e.g., sample block 112), as well as improve thermal uniformity throughout the sample block 112.

Heat pipes utilize a phase change of a coolant from liquid to vapor inside the pipe. In various exemplary embodiments, the coolant may be water or a refrigerant. The pipes include a hot side (e.g., condenser end) and a cold side (e.g., evaporator end). The hot side may be in thermal communication with a heat sink to transfer heat from the heat pipe or the hot side may be cooled by directly circulating a cooling fluid (e.g., air, water, etc.) around the heat pipe hot side. Condensed liquid may circulate through the heat pipe from the hot side to the cold side. In various embodiments, internal surface portions of the heat pipe may be lined with a wicking material capable of capillarity such that the condensed liquid travels via the wicking material from the hot side to the cold side. Other mechanisms for circulating the condensed liquid also may be used, such as, for example, relying on gravity, pumps, or other mechanisms known to those skilled in the art. The physics and principles of operation of heat pipe technology are known to those skilled in the art and have been used for cooling in various computer systems, including, for example, notebook computers. Suitable heat pipe configurations include straight heat pipes, for example with vapor flowing in the center region in one direction and condensed liquid traveling around interior peripheral surface portions (e.g., via the wicking material) of the pipe in the opposite direction. In various alternative embodiments, heat pipes may be U-shaped or form a loop. Other curved heat pipe configurations also may be utilized.

In various exemplary embodiments, one or more heat pipes, for example, any number of pipes ranging from about 1 to about 10, may be used to transfer heat from the heat sink 480, from the sample block 112, and/or from the sample holders.

The use of heat pipes also may facilitate the proportional integral derivative (PID) control of the temperature and/or provide a higher precision temperature stability and uniformity. As discussed above, the ability to minimize temperature nonuniformities and maintain the sample block 112 and/or sample 110 (e.g., directly or in a sample holder) at a substantially uniform temperature may be desirable in many circumstances to be able to maintain the samples at a uniform reaction temperature.

It also may be desirable to use a cooling system that has a relatively low thermal resistance, for example, in order to maintain the temperature of the heat sink 480 at approximately 45° C. for PCR or other desired temperature, as mentioned above. Using a conventional cooling system in the form of a heat sink and fan to achieve such a relatively low value of thermal resistance as that indicated above requires a heat sink of relatively large dimensions and a relatively powerful, and thus relatively loud, fan. Moreover, various structural arrangements and/or a relatively powerful fan may need to be provided to achieve effective circulation of air in and around the heat sink, since, for example, the heat sink (e.g., heat sink block and fins) are typically disposed underneath and in alignment with (e.g., aligned with the longitudinal axis of) the Peltier device, sample block, and/or samples. That is, as discussed above, the heat sink is typically positioned at a substantially central location of the thermal cycling instrument.

Heat pipes can achieve relatively low thermal resistances due to the relatively high thermal conductivity exhibited by heat pipe coolers. Also, when using one or more heat pipes as a cooling member, such as, for example, cooling member 592, 692, 792 or 1092, the heat sink (e.g., heat sink block and cooling fins) may be placed farther (e.g., offset) from the cooling area, the sample holders, and/or the sample block. This may provide greater flexibility in the arrangement of the cooling system, reduction in the overall size of the instrumentation, more efficient cooling, and/or minimization of undesired physical effects of the cooling system on the reaction chamber of a biological analysis instrument.

When using heat pipe technology, the heat sink may have dimensions ranging from about 40 mm by about 40 mm to about 80 mm by about 120 mm, for example. The fan may have a noise level ranging from about 15 dBA to about 60 dBA, for example.

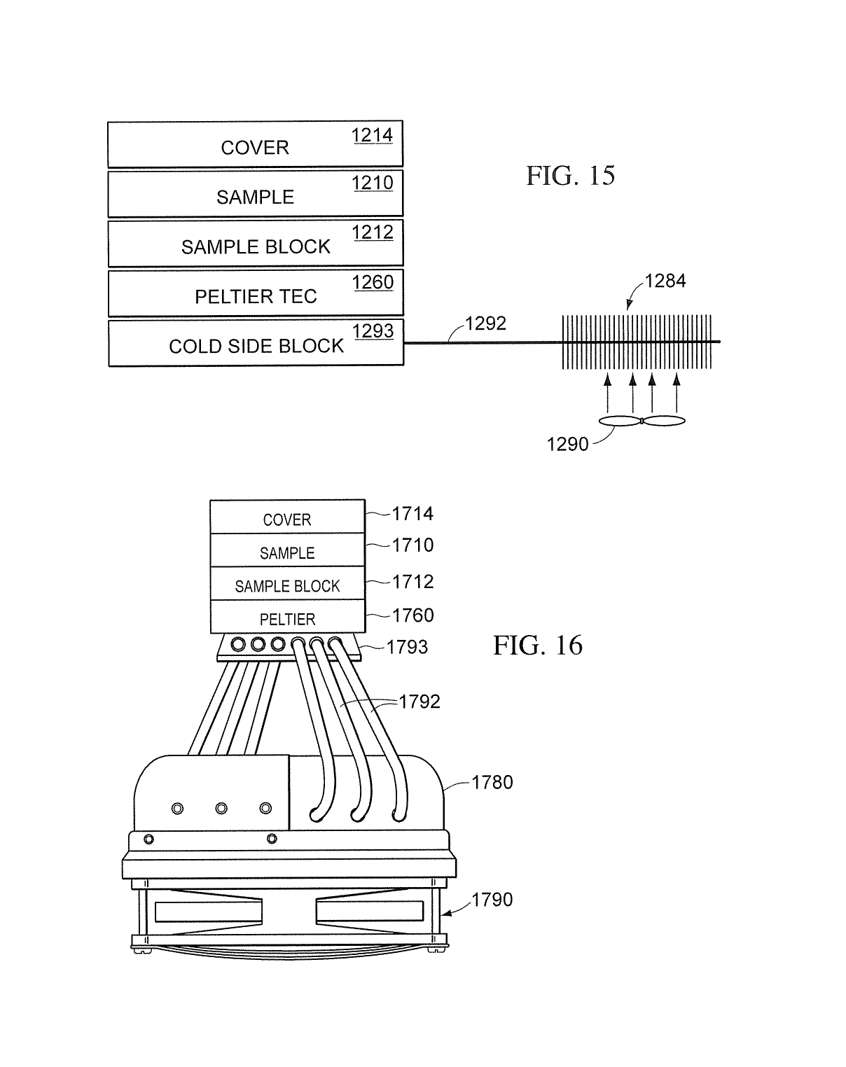

With reference to FIG. 15, a block diagram of an exemplary embodiment of a biological analysis instrument and thermal cycling system that uses heat pipe technology as the cooling member is depicted. In FIG. 15, many of the components are similar to those discussed with reference to FIG. 3, however, the control components, for example, like those in FIG. 3, are not depicted. Skilled artisans would understand that such control components may be utilized to control the thermal cycling times and temperatures in accordance with the teachings herein.

The system of FIG. 15 thus includes a cover 1214 (which may be heated for a PCR instrument) to cover the samples 1210 and a sample block 1212 configured to support the samples 1210. Suitable structures for the cover 1214, samples 1210, and sample block 1212 have been described above and may be used with the embodiment of FIG. 15. The system of FIG. 15 further includes, according to various exemplary embodiments, a Peltier thermoelectric device 1260 for heating and cooling the sample block 1210 and a cold side block 1293 into which the evaporative side of one or more heat pipes 1292 may be in thermal contact. In an alternative arrangement (not shown), one or more heat pipes 1292 may be placed in direct thermal contact with the Peltier device 1260. In FIG. 15, the one or more heat pipes 1292 may be attached to a cold side block 1293 at one end of the heat pipes 1292 (e.g., the end of the heat pipes 1292 where a coolant is vaporized) and attached to a heat sink 1284 (e.g., shown as fins in FIG. 12) at the other end of the heat pipes 1292 (e.g., the end where condensed coolant is collected and circulated back to the opposite end). A fan 1290 may be positioned to circulate air in and around the heat sink 1284. It should be understood that the heat sink 1284 may include a heat sink block connected to fins in a structural arrangement or may include heat sink pins similar to the structural arrangement of FIGS. 9 and 10.

Thus, according to various exemplary embodiments and as depicted in FIG. 15, using heat pipe technology may permit the use of higher power Peltier (thermoelectric) devices, thereby resulting in faster and more efficient thermal cycling and temperature changes. That is, due to their relatively low thermal resistance, heat pipes may dissipate heat more than conventional heat sinks of approximately equal size and permit Peltier devices of higher power to be used for heating the sample and/or sample block. Further, using heat pipe technology as a cooling member to provide cooling in a biological analysis instrument that relies on thermal cycling may permit greater flexibility in the arrangement of the heat sink relative to the rest of the thermal cycling system and/or may permit air to be circulated in and around the heat sink in a more optimal manner. In this way, a fan 1290 used for cooling the heat sink may be located distally to the reaction chamber of the biological analysis instrument, such as, for example, a flow cell, and provide effective cooling without undesired physical effects on the reaction chamber in accordance with the present teachings.

By way of example, the heat sink 480, including, for example, having fins or other heat-conducting members, may be provided in an offset relationship to (e.g., not aligned with) a Peltier device, sample block, and/or samples of the thermal cycling system. For example, the heat sink may be positioned between a longitudinal axis of the Peltier device, sample block, and/or samples (sample holder) and a fan, including in alignment with the fan, as shown in the exemplary arrangement of FIG. 15. Such positioning of the heat sink out of alignment with the Peltier device, sample block, and/or sample holders may permit an air path between a fan and the heat sink to be reduced, thereby permitting a relatively less powerful, and thus less noisy, fan to be used, which may minimize physical movement (e.g., vibration) of the sample in a reaction chamber. Moreover, positioning the heat sink away from the center of the thermal cycling instrument, for example, between a longitudinal axis of the sample block and/or sample holder and a fan, and/or proximate a periphery of the instrument and offset from the Peltier device, sample holder and/or sample block, may permit elimination of the fan. That is, the heat sink's proximity to the ambient air may provide sufficient heat transfer and cooling of the heat sink without the need for a fan.

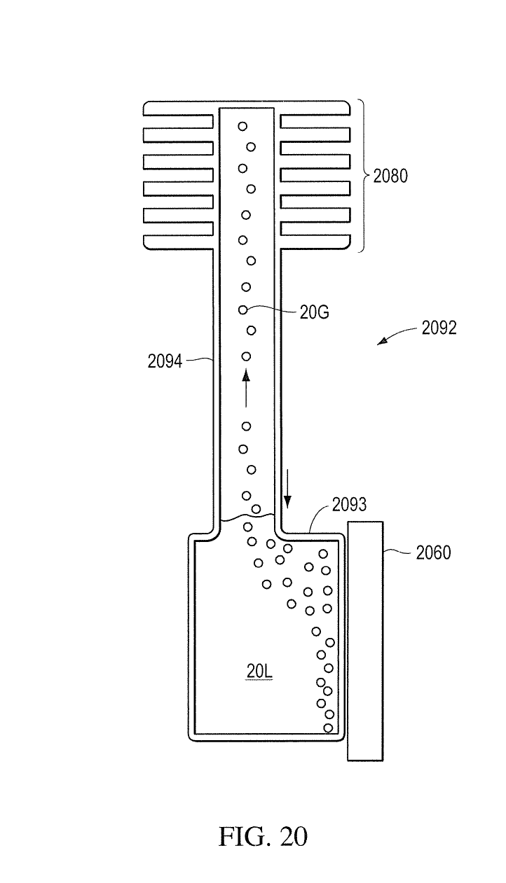

An exemplary embodiment of a cooling member that includes heat pipe cooling technology is schematically depicted in FIG. 20. The cooling member 2092 includes a reservoir 2093 containing a relatively low boiling point fluid, such as, for example, alcohol or other relatively low-boiling point fluid. The reservoir 2093 may be placed in thermal communication with a thermoelectric device 2060, which may be used to control a temperature of a reaction chamber, as described in various embodiments herein. The other components of the biological analysis instrument with which the cooling member 2092 and thermoelectric device 2060 may be in thermal communication are not illustrated in FIG. 20, but those having skill in the art would understand how those components, which are described throughout this application, would be used in combination with the exemplary embodiment of FIG. 20.

Heat being transferred from the thermoelectric device 2060 to the reservoir 2093 causes that fluid 20L in the reservoir 2093 to vaporize (e.g., boil). The phase change from liquid to vapor transfers heat from the thermoelectric device 2060 to provide cooling, for example, ultimately to a reaction chamber which has its temperature modulated by the thermoelectric device 2060. The cooling member 2092 also may include a pipe 2094 oriented substantially vertically. The vapor 20G may rise from the reservoir 2093 into the pipe 2094 in the direction of the arrow pointing upward in FIG. 20 and approximately through the center of the pipe 2094. The reservoir 2093 and pipe 2094 may form a closed system of recirculating fluid.

The end portion of the pipe 2094 that is opposite the end connecting to the reservoir 2093 may be positioned and configured to exchange heat with the environment, which may be cool enough to condense the vapor 20G back to a liquid 20L. The liquid 20L may then fall back down the pipe 2094 due to gravitational effects, approximately along the inner walls of the pipe 2094, and into the reservoir 2093 in the direction of the arrow pointing downward shown in FIG. 20. A heat sink 2080, which may be in the form of fins shown in FIG. 20, may be in thermal communication with the pipe 2094, for example at the end portion opposite the reservoir 2093, to increase the heat transfer from the pipe 2094 with the environment. The cooling member 2092 also may be used in conjunction with a fan (not shown) to provide cooling air across either the pipe 2094 or the pipe 2094 and heat sink 2080 to enhance heat transfer and cooling of the vapor 20G.

In various exemplary embodiments, the pipe 2094 may be located such that the end portion opposite the reservoir 2093 is distal to the thermoelectric device and/or a reaction chamber of a biological analysis instrument. For example, the pipe 2094 may be disposed so as to exchange heat with air that is outside of the ambient air stream surrounding the biological analysis instrument such that the air temperature is substantially unaffected by heating of the reaction chamber and/or heating effects associated with use of the reaction chamber for biological analysis.

Other embodiments of heat pipe cooling systems that may be used as the cooling member 592, 692, 792, 1092, or 1292 include those marketed by Thermacore International (Lancaster, Pa.), which comprise a vacuum-tight envelope, a wick structure and a working fluid. The heat pipe may be evacuated and back-filled with a small quantity of working fluid to saturate the wick. Inside the heat pipe, a vapor-liquid equilibrium is established. As heat enters the pipe at one end, the equilibrium is upset and generates vapor at a slightly higher pressure. This higher pressure vapor travels to the other condensing end where the slightly lower temperatures cause the vapor to condense and give up its latent heat of vaporization. Condensed fluid is then pumped back to the evaporator end by capillary forces developed in the wick structure. This continuous cycle transfers large quantities of heat with very low thermal gradients.

In various other embodiments, heat pipe coolers manufactured by Cooler Master Co., Ltd. of Taiwan, such as the Hyper 6 KHC-V81 model, and/or by Thermaltake Co., Ltd., such as the Big Typhoon model, may be used as the cooling member 592, 692, 792, 1092, or 1292.

FIG. 16 illustrates an exemplary embodiment of a cooling system that includes heat pipes, a heat sink, and a cooling fan having a similar arrangement as Thermaltake's Big Typhoon model for cooling in a biological analysis instrument utilizing thermal cycling, components of which are illustrated in block form in FIG. 16. In the exemplary embodiment of FIG. 16, therefore, the thermal cycling components include a cover 1714, which may be heated for a PCR instrument, placed over samples 1710 (which may be contained in various types of sample containers in accordance with the teachings herein), a sample block 1712 configured to hold the samples 1710, and a Peltier thermoelectric device 1760. A plurality of heat pipes 1792 are placed in thermal contact with the Peltier device 1760 at one end of the heat pipes 1792 to absorb heat from the thermal cycling system and vaporize the circulating coolant in the heat pipes 1792. In the exemplary arrangement of FIG. 16, the heat pipes 1792 are placed in a block 1793 that can form a planar surface which facilitates attachment to the Peltier device 1760. However, it should be understood that the heat pipes 1792 also may be placed directly in contact with the Peltier device 1760. The other end of the heat pipes 1792 are in thermal contact with a heat sink 1780. A fan 1790 is positioned beneath the heat sink 1780 in FIG. 16 to circulate air to cool the heat sink 1780. The heat pipes 1792 therefore exchange heat with the heat sink 1780 to condense the coolant circulating in the heat pipes 1792. As described above, the condensed coolant then travels back to the opposite end of the heat pipes 1792 in thermal contact with the other components of the thermal cycling system. By way of example, the condensed coolant may travel via a wicking material provided in the heat pipes, although other mechanisms for circulating the condensed coolant also may be used, as known to those skilled in the art.

Although in the exemplary embodiment of FIG. 16, the heat pipes 1792 are in thermal contact with a Peltier thermoelectric device 1760, it should be understood that the heat pipes 1792 also may be in thermal contact with the sample block 1712, samples 1710, and/or other heating and/or cooling elements. Also, although the exemplary embodiment of FIG. 16 depicts the heat sink 1780 and fan 1790 substantially in alignment (e.g., along a longitudinal axis) with the various components 1710, 1712, 1760, and 1714, it should be understood that the heat sink 1780 and fan 1790 may be offset from the thermal cycling components, similar to that described above and shown with reference to FIG. 15, for example. For example, the heat pipes 1792 may be arranged and configured such that the heat sink 1780 and fan 1790 are disposed to a side of and distal to the thermal cycling components. 1710, 1712, 1760, and 1714.

Commercially available heat pipe coolers that may be used for cooling in biological analysis instruments, such as PCR and flow cell instruments, in accordance with the disclosure herein, may be capable of achieving relatively low thermal resistances (e.g., less than 15° C./W) at relatively low fan noise levels (e.g., 16 dBA and 20 dBA). Conventional heat sink and fan combinations require louder fans to achieve relatively low thermal resistances. When such a relatively loud fan is used for cooling a heat sink of a flow cell instrument, for example, and placed in proximity of the flow cell (e.g., coupled to the heat sink which is coupled to the flow cell), such a relatively louder, and thus bigger, fan causes undesired movement (e.g., vibration) of the reaction chamber of the flow cell. Using heat pipe cooling, therefore, may permit a quieter fan to be used to cool the heat sink and/or may eliminate the need for a fan altogether. Moreover, as described above, heat pipe cooling may permit the fan and heat sink to be placed at a distal location from the reaction chamber (e.g., of a flow cell).

Based on the relatively low temperature profile and minimal variation of a heat sink when using heat pipes for cooling in a biological analysis instrument relying on thermal cycling, it may be possible to remove more heat from the system, thereby also achieving relatively fast thermal cycling times. Also, when using heat pipes, a quieter fan (or no fan) may be used to achieve the same temperature of the heat sink than when using a conventional heat sink and fan combination for cooling.

The various exemplary heat pipe embodiments described above assist in achieving desired temperature gradients due to the ability to exert greater control over the cooling effects of heat pipes. Thus, by controlling the heat pipes, for example, independently of each other through the controller and various bus lines and sensors, various regions of the sample holders 110, 1210, or 1710, the sample block 112, 1212, or 1712, and/or the heat sink may be cooled by different amounts and/or rates in order to achieve desired temperature gradients among some or all of the samples 110, 1210, or 1710.

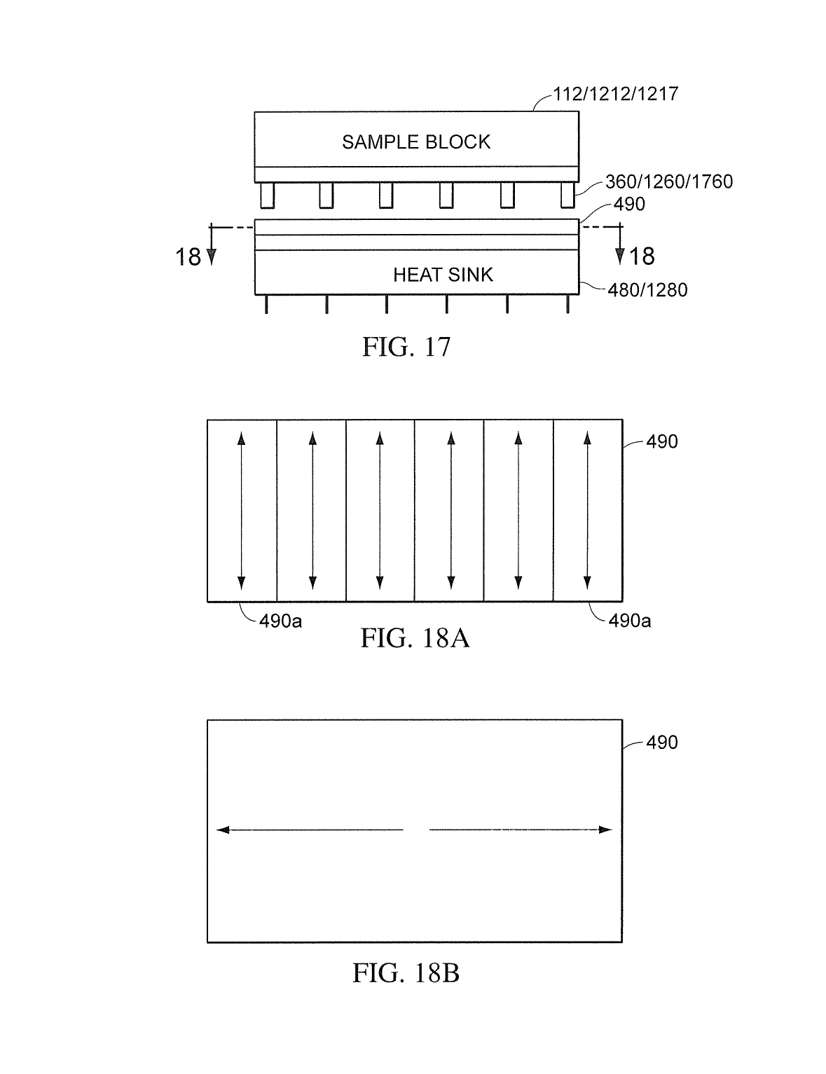

As depicted in FIG. 17, in some exemplary embodiments, the carbon discussed above, may be substantially in the form of a block 490 provided as an intermediate layer between the heat sink 480 and thermoelectric device 360. The block 490 may be oriented to conduct heat in a vertical direction away from the sample block 112, although other orientations may be selected depending on the application and desired heat conduction. By way of example only, as shown in FIG. 18A, which is a view taken from line 18-18 in FIG. 17, the block 490 may comprise six 2×8 segments 490a forming a block 490 having overall 12×8 dimensions that correspond to the 12×8 sample block 112. Aside from conducting heat in a vertical direction (i.e., away from or toward the sample block 112 and heat sink 480), conduction in each segment 490a may take place along the long axis (i.e., in the direction of the arrows shown in FIG. 18A). In this manner, the end segments (e.g., the end segments 490a to the left and the right of the center of the block) would have a similar environment (e.g., temperature) as the center segments, which may minimize temperature variations between the center and end samples in the sample block 112. In another example, depicted in FIG. 18B, which also is view taken from line 18-18 in FIG. 17, the block 490 may be formed as a single piece and may be oriented to conduct heat in the vertical direction and along the long axis of the block 490, as depicted by the arrows in FIG. 18B. This orientation may minimize temperature variations across the sample block 112 (e.g., along a direction substantially perpendicular to the arrows shown in FIG. 18B) used in conjunction with the cooling system.

Although the various cooling systems discussed above may reduce temperature nonuniformity experienced by the samples during temperature cycling of the samples through the various incubation stages, in some applications it may be desirable to induce controlled (e.g., predetermined) temperature gradients among the samples, for example, during a PCR, sequencing, or other biological analysis temperature protocol. The various exemplary cooling members described above assist in achieving desired temperature gradients due to the ability to exert greater control over the cooling effects produced by these cooling members. Thus, by controlling the cooling members through the controller and various bus lines and sensors, various regions of the sample holders, the sample block, and/or the heat sink may be cooled by differing amounts and/or rates to achieve desired temperature gradients among some or all of the samples.

It should be noted that various exemplary embodiments shown and described herein, including, for example, the exemplary embodiments of FIGS. 9-16, use a heat sink and/or a thermoelectric device to assist in modulating the temperature (e.g., heating and/or cooling) of reaction chambers. Such heat sinks and/or thermoelectric devices may not be required, however. For example, in the exemplary embodiments of FIGS. 9 and 10, it may be possible to remove the heat sink and/or the thermoelectric device and blow air via the distal fan directly onto, for example, the heater block and modulate the temperature of the reaction chamber (and sample therein) by setting a temperature of the air which is blown. Likewise, in the embodiment relying a recirculating fluid, as illustrated in the exemplary embodiments of FIGS. 11-14, for example, the temperature of the recirculating fluid also may be set and used to modulate the temperature of the reaction chamber (and sample therein), for example, without the use of a thermoelectric device.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

It is noted that, as used in this specification and the appended claims, the singular forms “a,” “an,” and “the,” include plural referents unless expressly and unequivocally limited to one referent. Thus, for example, reference to “a biological” includes two or more different biological samples. As used herein, the term “include” and its grammatical variants are intended to be non-limiting, such that recitation of items in a list is not to the exclusion of other like items that can be substituted or added to the listed items.

Throughout the specification, reference is made to biological sample and/or biological samples. It should be understood that the biological analysis instruments in accordance with the present teachings are configured to perform processes on multiple amounts of sample simultaneously. Further, differing types of sample may be processed simultaneously. Thus, when reference is made to a biological sample being provided in a reaction chamber, it should be understood that the term may refer to either a single type of sample in a single amount, multiple amounts of a single type of sample, and/or multiple amounts of differing types of sample. The term also may be used to refer to a bulk amount of substance placed in the reaction chamber. Further, in its broadest sense, the term sample can include the various reagents, etc. that are introduced to the chamber to perform an analysis or other process therein.

It will be apparent to those skilled in the art that various modifications and variations can be made to the embodiments of the present disclosure without departing from the scope the teachings herein. Other embodiments of the disclosure will be apparent to those skilled in the art from consideration of the specification and practice of the teachings disclosed herein. It is intended that the specification and examples be considered as exemplary only.

What is claimed is:

1. A device for performing biological analysis, the device comprising:
at least one reaction chamber configured to receive at least one sample for biological analysis; and
a thermal system configured to modulate a temperature of the at least one reaction chamber to cycle a temperature of the at least one biological sample, the thermal system comprising a cooling system configured to cool the at least one reaction chamber,
wherein the cooling system comprises a cooling fluid source positioned distally from the at least one reaction chamber, the cooling fluid source being in flow communication with at least one conduit configured to flow cooling fluid from the cooling fluid source to at least one location in thermal communication with the at least one reaction chamber.

2. The device of claim 1, further comprising at least one flow cell defining the at least one reaction chamber.

3. The device of claim 1, wherein the at least one reaction chamber is configured to receive a substrate of biological templates for performing sequencing thereof.

4. The device of claim 1, wherein the cooling fluid source is positioned to minimize movement of the at least one reaction chamber caused by the cooling fluid source.

5. The device of claim 1, wherein the cooling fluid source is positioned to minimize vibration of the at least one reaction chamber caused by the cooling fluid source.

6. The device of claim 1, further comprising a heat sink in thermal communication with the at least one reaction chamber.

7. The device of claim 6, wherein the cooling fluid source is spaced from the heat sink.

8. The device of claim 7, further comprising a thermoelectric device in thermal communication with the at least one reaction chamber.

9. The device of claim 7, wherein the cooling fluid source comprises a fan and the at least one conduit comprises at least one duct configured to flow the air from the fan to circulate about the heat sink.

10. The device of claim 9, wherein the heat sink comprises a plurality of pins.

11. The device of claim 10, wherein the plurality of pins are in thermal communication with the thermoelectric device.

12. The device of claim 1, wherein the cooling fluid comprises air.

13. The device of claim 1, wherein the cooling fluid source comprises a fan.

14. The device of claim 13, wherein the at least one conduit comprises at least one duct configured to receive air from the fan and flow the air to the at least one location proximate the at least one reaction chamber.

15. The device of claim 13, wherein the fan has a capacity of greater than about 50 cfm.

16. The device of claim 1, further comprising a switch configured to interrupt power to the cooling fluid source.

17. The device of claim 16, wherein the at least one reaction chamber comprises a door configured to provide access to the at least one reaction chamber when the door is in an open position, and wherein the switch is configured to interrupt power to the cooling fluid source in response to the door being placed in the open position.

18. The device of claim 16, wherein the cooling fluid source comprises a fan and the switch is configured to interrupt power to the fan.

19. The device of claim 16, wherein the thermal system further comprises a thermoelectric device and wherein the switch is configured to interrupt power to the thermoelectric device.

20. The device of claim 1, wherein the cooling fluid source comprises a supply of cooling fluid.

21. The device of claim 20, wherein the cooling fluid comprises at least one of ethylene glycol, Propylene Glycol, methanol, water, antifreeze agents, or a combination thereof.

22. The device of claim 20, wherein the cooling fluid source comprises a recirculating chiller.

23. The device of claim 22, wherein the recirculating chiller circulates a cooling fluid to at least one location proximate and in thermal communication with the at least one reaction chamber.

24. The device of claim 23, wherein the recirculating chiller comprises a centrifugal pump configured to pump the cooling fluid through the at least one conduit.

25. The device of claim 20, wherein the cooling fluid source comprises a recirculating supply of cooling fluid that flows through the at least one conduit.

26. The device of claim 25, wherein the at least one conduit comprises a heat pipe.

27. The device of claim 1, wherein the at least one reaction chamber comprises two reaction chambers

28. The device of claim 27, wherein the reaction chambers are defined by flow cells.

29. The device of claim 27, wherein the at least one conduit comprises a plurality of conduits configured to flow cooling fluid to each of the reaction chambers.

30. The device of claim 29, wherein the plurality of conduits are configured to flow cooling fluid to each of the reaction chambers one of in parallel and in series.

31. The device of claim 1, further comprising a detection mechanism configured to monitor the at least one reaction chamber.

32. A device for performing biological analysis, the device comprising:
at least one reaction chamber configured to receive at least one sample for biological analysis; and
a thermal system configured to modulate a temperature of the at least one reaction chamber to cycle a temperature of the at least one biological sample, the thermal system comprising a cooling system;
wherein the cooling system is configured to minimize physical movement of the at least one reaction chamber caused by the cooling system.

33. The device of claim 32, wherein the cooling system comprises at least one cooling member positioned distally from the at least one reaction chamber.

34. The device of claim 32, wherein the cooling system comprises a cooling member chosen from at least one of a fan, a circulating cooling fluid, a synthetic jet ejector array, a vibration-induced droplet atomization system, a vibrating diaphragm system, a piezo fan, a Cold Gun, a microchannel cooling loop, a Cool Chip, and at least one heat pipe.

35. The device of claim 33, wherein the at least one reaction chamber is defined by at least one flow cell configured to receive a substrate containing biological templates for performing sequencing thereof.

36. The device of claim 32, wherein the at least one reaction chamber is defined by at least one flow cell configured to receive a substrate of biological templates for performing sequencing thereof.

37. The device of claim 36, wherein the cooling system comprises at least one cooling member chosen from a fan and a circulating cooling fluid supply.

38. The device of claim 32, wherein the cooling system comprises a reservoir containing a fluid and at least one pipe in flow communication with the reservoir, the fluid being configured to change phase from liquid to vapor in the reservoir and from vapor to liquid in the at least one pipe.

39. The device of claim 38, wherein the at least one pipe is oriented so as to permit liquid to return to the reservoir via gravity.

40. A method of performing biological analysis, the method comprising:
supplying at least one reaction chamber with at least one biological sample for biological analysis; and
modulating a temperature of the at least one reaction chamber to cycle a temperature of the at least one biological sample, wherein modulating the temperature of the at least one reaction chamber comprises cooling the at least one reaction chamber,
wherein the cooling comprises flowing a cooling fluid from a cooling fluid source positioned distally from the at least one reaction chamber to at least one location proximate to and in thermal communication with the at least one reaction chamber via at least one conduit.

41. The method of claim 40, wherein supplying the at least one reaction chamber comprises supplying a substrate comprising the at least one biological sample to the at least one reaction chamber.

42. The method of claim 41, further comprising performing sequencing of the at least one biological sample.

43. The method of claim 42, wherein supplying the at least one reaction chamber further comprises supplying at least one reaction chamber defined by at least one flow cell.

44. The method of claim 40, wherein cooling the at least one reaction chamber comprises cooling the at least one reaction chamber to minimize movement of the at least one reaction chamber caused by the cooling system.

45. The method of claim 40, further comprising transferring heat from the at least one reaction chamber via a heat sink.

46. The method of claim 45, wherein modulating the temperature of the at least one reaction chamber comprises modulating the temperature via a thermoelectric device.

47. The method of claim 46, wherein the cooling fluid source comprises a fan and the at least one conduit comprises a duct, and wherein the cooling comprises flowing air from the fan through the at least one duct to circulate about the heat sink.

48. The method of claim 40, wherein cooling the at least one reaction chamber comprises flowing a cooling fluid from a supply of cooling fluid.

49. The method of claim 48, wherein flowing the cooling fluid comprises recirculating the cooling fluid.

50. The method of claim 49, wherein flowing the cooling fluid comprises pumping the cooling fluid.

51. The method of claim 40, wherein supplying the at least one reaction chamber with at least one biological sample for analysis comprises supplying two reaction chambers with at least one biological sample for analysis, and wherein flowing the cooling fluid comprises flowing the cooling fluid to the reaction chambers one of in parallel and in series.

52. A method for performing biological analysis, the method comprising:
supplying at least one reaction chamber with at least one biological sample for biological analysis; and
modulating a temperature of the at least one reaction chamber to cycle a temperature of the at least one biological sample, wherein modulating the temperature of the at least one reaction chamber comprises cooling the at least one reaction chamber,
wherein cooling the at least one reaction chamber comprises minimizing physical movement of the at least one reaction chamber caused by the cooling.

53. The method of claim 52, wherein cooling the at least one reaction chamber comprises cooling the at least one reaction chamber via at least one cooling member positioned distally from the at least one reaction chamber.

54. The method of claim 52, wherein cooling the at least one reaction chamber comprises cooling the at least one reaction chamber via at least one of a fan, a circulating cooling fluid, a synthetic jet ejector array, a vibration-induced droplet atomization system, a vibrating diaphragm system, a piezo fan, a Cold Gun, a microchannel cooling loop, a Cool Chip, and at least one heat pipe.

55. The method of claim 52, further comprising performing sequencing of the at least one biological sample.

56. The method of claim 52, wherein supplying the at least one reaction chamber further comprises supplying at least one reaction chamber defined by at least one flow cell.

57. The method of claim 52, further comprising transferring heat from the at least one reaction chamber via a heat sink.

58. The method of claim 52, wherein modulating the temperature of the at least one reaction chamber comprises modulating the temperature via a thermoelectric device.

59. The method of claim 52, wherein cooling the at least one reaction chamber comprises flowing air from a fan through the at least one duct to a location proximate to and in thermal communication with the at least one reaction chamber.

60. The method of claim 52, wherein cooling the at least one reaction chamber comprises flowing a cooling fluid from a supply of cooling fluid to a location proximate to and in thermal communication with the at least one reaction chamber

61. The method of claim 60, wherein flowing the cooling fluid comprises recirculating the cooling fluid.

62. The method of claim 60, wherein supplying the at least one reaction chamber with at least one biological sample for analysis comprises supplying two reaction chambers with at least one biological sample for analysis, and wherein flowing the cooling fluid comprises flowing the cooling fluid to the reaction chambers one of in parallel and in series.
